(19) United States
(12) Patent Application Publication
(10) Pub. No.: US 2021/0325273 A1
(43) Pub. Date: Oct. 21, 2021

(54) PRESSURE SENSOR

(71) Applicant: MIKUNI CORPORATION, Tokyo (JP)

(72) Inventors: Tomoya SATO, Iwate (JP); Katsuhiko FUKUI, Iwate (JP)

(73) Assignee: MIKUNI CORPORATION, Tokyo (JP)

(21) Appl. No.: 17/292,449

(22) PCT Filed: Jan. 10, 2019
(86) PCT No.: PCT/JP2019/000493

§ 371 Date: May 9, 2021

(51) Int. Cl. G01L 23/10; G01L 19/06; G01L 9/08; G01L 9/12

(52) U.S. Cl. CPC G01L 23/10; G01L 9/12; G01L 9/08; G01L 19/06

(57) ABSTRACT

A pressure sensor of the present invention comprises a cylindrical housing (10, 210); a diaphragm (30) which is fixed to the front end of the housing and exposed to a pressure medium; a pressure measuring member (70, 270) comprising a first electrode (71), a piezoelectric element (72) and a second electrode (73) laminated in sequence inside the housing; a first conductor (91, 210) in a long shape which is electrically connected to the first electrode; a second conductor (92, 290) in a long shape which is electrically connected to the second electrode; and a restricting member (100, 300) having insulation which is arranged inside the housing so as to restrict relative movement between the first conductor and the second conductor According to this configuration, it is possible to suppress or prevent variations in parasitic capacitance so as to suppress or prevent the occurrence of noise.

### BACKGROUND

### Technical Field

The present invention relates to a pressure sensor for detecting a pressure of a pressure medium, and more particularly to a pressure sensor for detecting a pressure of a pressure medium such as combustion gas in a combustion chamber of an engine.

### Related Art

As a conventional pressure sensor, a pressure sensor for detecting a pressure of combustion gas in a combustion chamber of an engine is known, and the pressure sensor includes a housing in a cylindrical shape, a diaphragm coupled to a front end of the housing, a transmission portion serving as a first electrode integrally formed with the diaphragm, a piezoelectric element arranged in contact with the transmission portion, a second electrode arranged to clamp the piezoelectric element in cooperation with the transmission portion, a conductive lead portion electrically connected to the second electrode, and an insulating pipe inserted into the housing and having a lead portion inserted in an insertion hole of the pipe (for example, Patent literature 1).

In this pressure sensor, the lead portion is inserted into the insulating pipe and the pipe is inserted into the housing.

Therefore, when a vibration of the engine is transmitted to the lead portion and the lead portion moves relative to the housing, a parasitic capacitance (stray capacitance) between the housing and the lead portion may be varied, and noise may be generated in an output signal.

In addition, as another pressure sensor, a combustion pressure sensor for detecting a combustion pressure of combustion gas in a combustion chamber is known, and the combustion pressure sensor includes a housing in a cylindrical shape, a diaphragm coupled to a front end of the housing, a first electrode arranged in contact with the diaphragm, a piezoelectric element arranged in contact with the first electrode, a second electrode arranged to clamp the piezoelectric element in cooperation with the first electrode, a protrusion serving as a conductor protruding from the second electrode, a preload application portion for applying a preload to the piezoelectric element while passing the protrusion in a non-contact manner, an O-ring that supports the protrusion in a radial direction with respect to the preload application portion, a spring pin and a coil spring electrically connected to the protrusion, a rod-shaped conductive portion arranged in contact with the coil spring, and a resin portion having a conductive portion insert-molded therein and inserted in the housing with a gap left therebetween (for example, Patent literature 2).

In this combustion pressure sensor, the spring pin and the coil spring are arranged inside the housing, and the resin portion is inserted into the housing with a gap left between the resin portion and the inner wall of the housing.

Therefore, when a vibration of the engine is transmitted to a conductor including the spring pin, the coil spring and the conductive portion, and the conductive portion moves relative to the housing, a parasitic capacitance (stray capacitance) between the housing and the conductor may be varied, and noise may be generated in an output signal.

### LITERATURE OF RELATED ART

### [Patent Literature]

Patent literature 1: Japanese Patent No. 5006695
Patent literature 2: Japanese Patent Laid-Open No. 2016-121955

### SUMMARY

### Problems to be Solved

The present invention has been made in view of the above circumstances, and an object of the present invention is to provide a pressure sensor that can solve conventional problems and suppress or prevent variations in parasitic capacitance so as to suppress or prevent occurrence of noise.

### Means to Solve Problems

The pressure sensor of an embodiment of the present invention includes: a housing in a cylindrical shape; a diaphragm, fixed to a front end of the housing and exposed to a pressure medium; a pressure measuring member including a first electrode, a piezoelectric element and a second electrode laminated in sequence inside the housing; a first conductor in a long shape, electrically connected to the first electrode; a second conductor in a long shape, electrically connected to the second electrode; and a restricting member having insulation, arranged in the housing and configured to restrict a relative movement between the first conductor and the second conductor.

The pressure sensor may adopt a configuration in which the restricting member is formed of an elastic material.

The pressure sensor may adopt a configuration in which the pressure sensor further includes: a preload applying member, arranged inside the housing and configured to press the pressure measuring member toward the diaphragm to apply a preload, and the restricting member is arranged in a region deviating from the preload applying member.

The pressure sensor may adopt a configuration in which the housing includes: an outer housing; and a sub-housing being fitted and fixed inside the outer housing. The diaphragm, the pressure measuring member, and the preload applying member are arranged in the sub-housing; and the restricting member is arranged in the outer housing.

A first embodiment of the pressure sensor may adopt a configuration in which the first conductor is a first lead wire arranged inside the housing, the second conductor is a second lead wire arranged inside the housing, and the first lead wire and the second lead wire are fitted and fixed to the restricting member.

The pressure sensor according to the first embodiment may adopt a configuration in which the restricting member is fitted and fixed to the housing.

The pressure sensor according to the first embodiment may adopt a configuration in which the pressure sensor further includes: a connector, fixed to a rear end of the housing. The first lead wire is electrically connected to a first terminal of the connector, the second lead wire is electrically connected to a second terminal of the connector, and the restricting member is arranged between the preload applying member, and the first terminal and the second terminal.

The pressure sensor according to the first embodiment may adopt a configuration in which the restricting member is a molded rubber having a long columnar shape in an axial direction of the housing. The molded rubber has: a first fitting hole that extends to penetrate in the axial direction so as to allow the first lead wire to be fitted and inserted therethrough; and a second fitting hole that extends to penetrate in the axial direction so as to allow the second lead wire to be fitted and inserted therethrough.

The pressure sensor according to the first embodiment may adopt a configuration in which the restricting member is formed as a molded rubber having a long columnar shape in an axial direction of the housing. The molded rubber has: a first fitting groove that extends in the axial direction so as to allow the first lead wire to be fitted and inserted therethrough; and a second fitting groove that extends in the axial direction so as to allow the second lead wire to be fitted and inserted therethrough.

The pressure sensor according to the first embodiment may adopt a configuration in which the restricting member is formed so as to be partially in contact with an inner wall surface of the housing.

A second embodiment of the pressure sensor may adopt a configuration in which the housing is formed so as to also serve as the first conductor, the second conductor is a lead wire arranged inside the housing, the lead wire is fitted and fixed to the restricting member, and the restricting member is fitted and fixed to the housing.

The pressure sensor according to the second embodiment may adopt a configuration in which the pressure sensor further includes: a connector, fixed to a rear end of the housing, the lead wire is electrically connected to a terminal of the connector, and the restricting member is arranged between the terminal and the preload applying member.

The pressure sensor according to the second embodiment may adopt a configuration in which the restricting member is formed as a molded rubber having a long columnar shape in an axial direction of the housing, and the molded rubber has a fitting hole that extends to penetrate in the axial direction so as to allow the lead wire to be fitted and inserted therethrough.

The pressure sensor according to the second embodiment may adopt a configuration in which the restricting member is formed as a molded rubber having a long columnar shape in the axial direction of the housing, and the molded rubber has a fitting groove that extends in the axial direction so as to allow the lead wire to be fitted and inserted therethrough.

The pressure sensor according to the second embodiment may adopt a configuration in which the restricting member is formed so as to be partially in contact with an inner wall surface of the housing.

### Effect

According to the pressure sensor having the above configuration, it is possible to obtain a pressure sensor that can suppress or prevent variations in parasitic capacitance so as to suppress or prevent occurrence of noise.

### BRIEF DESCRIPTION OF THE DRAWINGS

FIG. 1 is an external perspective view showing a pressure sensor according to a first embodiment of the present invention.

FIG. 2 is a cross-sectional view taken along the axis of the pressure sensor according to the first embodiment.

FIG. 3 is an external perspective view showing a sensor module and a restricting member included in the pressure sensor according to the first embodiment.

FIG. 4 is an exploded perspective view showing the sensor module and the restricting member included in the pressure sensor according to the first embodiment.

FIG. 5 is an exploded perspective view of the sensor module included in the pressure sensor according to the first embodiment.

FIG. 6 is an enlarged cross-sectional view in which the front end side of the cross-sectional view shown in FIG. 2 is partially enlarged.

FIG. 7 is a cross-sectional view of the sensor module included in the pressure sensor according to the first embodiment.

FIG. 8 is a cross-sectional view of the sensor module at a position rotated 90 degrees around an axis S with respect to the cross section shown in FIG. 7.

FIG. 9 is a cross-sectional view obtained by cutting, in a plane perpendicular to the axis, a region including the restricting member in the pressure sensor according to the first embodiment.

FIG. 10 is an external perspective view showing a first variation example of the restricting member applicable to the pressure sensor according to the first embodiment and a sensor module.

FIG. 11 is an external perspective view showing the restricting member of the first variation example shown in FIG. 10.

FIG. 12 is a cross-sectional view obtained by cutting, in a plane perpendicular to the axis, a region including the restricting member in a pressure sensor using the restricting member of the first variation example shown in FIG. 10.

FIG. 13 is an external perspective view showing a second variation example of the restricting member applicable to the pressure sensor according to the first embodiment.

FIG. 14 is an external perspective view showing a third variation example of the restricting member applicable to the pressure sensor according to the first embodiment.

FIG. 15 is a cross-sectional view obtained by cutting, in a plane perpendicular to the axis, a region including the restricting member in a pressure sensor using the restricting member of the third variation example shown in FIG. 14.

FIG. 16 is an external perspective view showing a fourth variation example of the restricting member applicable to the pressure sensor according to the first embodiment.

FIG. 17 is an external perspective view showing a fifth variation example of the restricting member applicable to the pressure sensor according to the first embodiment.

FIG. 18 is a cross-sectional view obtained by cutting, in a plane perpendicular to the axis, a region including the restricting member in a pressure sensor using the restricting member of the fifth variation example shown in FIG. 17.

FIG. 19 is an external perspective view showing a pressure sensor according to a second embodiment of the present invention.

FIG. 20 is a cross-sectional view taken along the axis of the pressure sensor according to the second embodiment.

FIG. 21 is an external perspective view showing a sensor module and a restricting member included in the pressure sensor according to the second embodiment.

FIG. 22 is an exploded perspective view showing the sensor module and the restricting member included in the pressure sensor according to the second embodiment.

FIG. 23 is an exploded perspective view of the sensor module included in the pressure sensor according to the second embodiment.

FIG. 24 is an enlarged cross-sectional view in which the front end side of the cross-sectional view shown in FIG. 20 is partially enlarged.

FIG. 25 is a cross-sectional view of the sensor module included in the pressure sensor according to the second embodiment.

FIG. 26 is a cross-sectional view obtained by cutting, in a plane perpendicular to the axis, a region including the restricting member in the pressure sensor according to the second embodiment.

FIG. 27 is an external perspective view showing a first variation example of the restricting member applicable to the pressure sensor according to the second embodiment.

FIG. 28 is an external perspective view showing a second variation example of the restricting member applicable to the pressure sensor according to the second embodiment.

FIG. 29 is a cross-sectional view obtained by cutting, in a plane perpendicular to the axis, a region including the restricting member in a pressure sensor using the restricting member of the second variation example shown in FIG. 28.

FIG. 30 is an external perspective view showing a third variation example of the restricting member applicable to the pressure sensor according to the second embodiment.

FIG. 31 is an external perspective view showing a fourth variation example of the restricting member applicable to the pressure sensor according to the second embodiment.

### DESCRIPTION OF THE EMBODIMENTS

Hereinafter, an embodiment of the present invention is described with reference to the accompanying drawings.

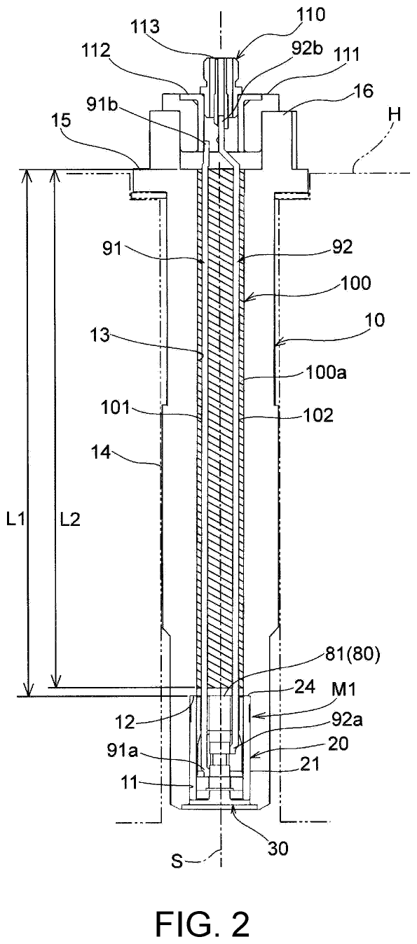

As shown in FIG. 2, a pressure sensor according to a first embodiment is attached to a cylinder head H of an engine, so as to detect a pressure of combustion gas in a combustion chamber serving as a pressure medium.

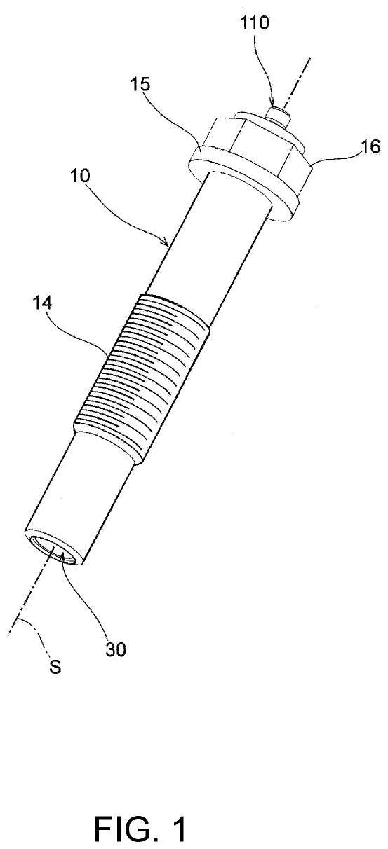

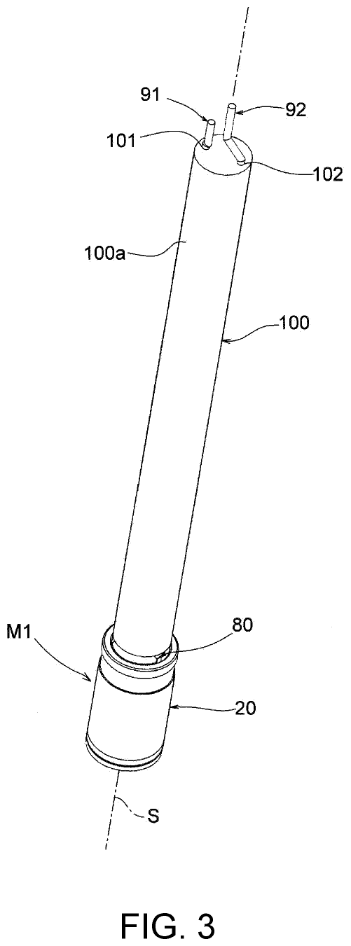

As shown in FIGS. 1 to 3 and FIG. 6, the pressure sensor according to the first embodiment includes an outer housing 10 and a sub-housing 20 being housings in a cylindrical shape, a diaphragm 30, a holding plate 40, a positioning member 50, a heat insulating member 60, a pressure measuring member 70, a preload applying member 80, a first lead wire 91 serving as a first conductor, a second lead wire 92 serving as a second conductor, a restricting member 100, and a connector 110.

The pressure measuring member 70 includes a first electrode 71, a piezoelectric element 72, and a second electrode 73 which are laminated in sequence from a front end side of the housing in the axis S direction.

The preload applying member 80 includes a fixing member 81 and an insulating member 82.

As shown in FIG. 1 and FIG. 2, the outer housing 10 is formed in a cylindrical shape extending in the axis S direction by using a metal material such as precipitation hardening stainless steel or ferritic stainless steel.

In addition, the outer housing 10 includes a fitting inner peripheral wall 11 in a cylindrical shape being located on a front end side, a step portion 12 in an annular shape, a through hole 13 in a cylindrical shape, a male screw portion 14 formed on an outer peripheral surface, a flange portion 15, and a connector connecting portion 16 located at a rear end.

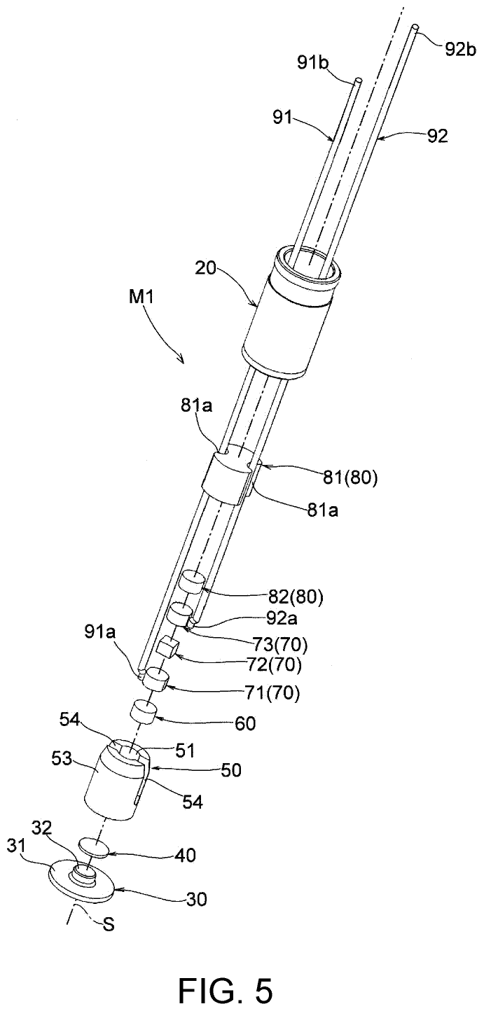

As shown in FIGS. 5 to 8, the sub-housing 20 is formed in a cylindrical shape extending in the axis S direction by using a metal material such as precipitation hardening stainless steel or ferritic stainless steel.

In addition, the sub-housing 20 includes an outer peripheral wall 21 in a cylindrical shape being fitted to the fitting inner peripheral wall 11, an inner peripheral wall 22 in a cylindrical shape being centered on the axis S, a front end surface 23 in an annular shape, and an inner-side end surface 24 in an annular shape.

Besides, the sub-housing 20 is fitted inside the outer housing 10 and fixed by welding or the like in a state that the diaphragm 30, the holding plate 40, the positioning member 50, the heat insulating member 60, the pressure measuring member 70, the preload applying member 80, the first lead wire 91, and the second lead wire 92 are assembled.

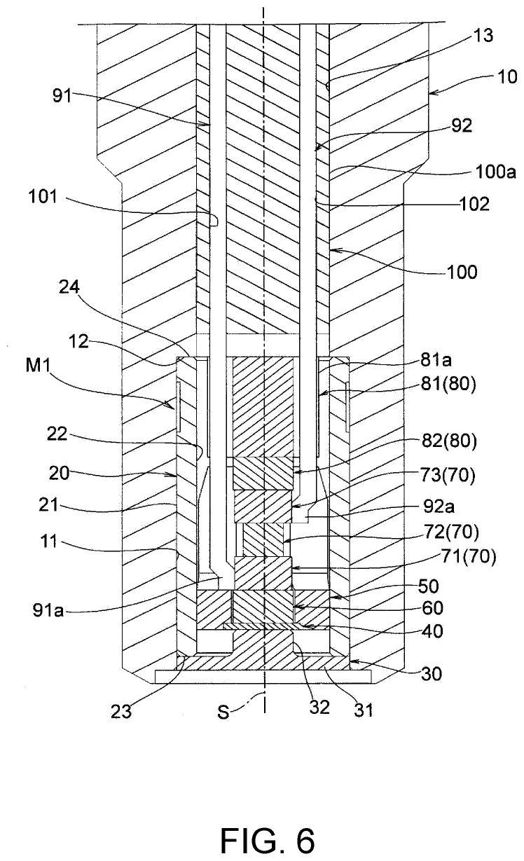

The diaphragm 30 is formed by using a metal material such as stainless steel having precipitation hardening property, and includes a flexible plate-shaped portion 31 and a protrusion 32 formed continuously on the flexible plate-shaped portion 31, as shown in FIGS. 6 to 8.

The flexible plate-shaped portion 31 is formed in an elastically deformable disk shape, and its outer edge region is fixed to the front end surface 23 of the sub-housing 20 by welding or the like.

A load corresponding to the pressure of the combustion gas acts on the flexible plate-shaped portion 31, and the flexible plate-shaped portion 31 is elastically deformed in the axis S direction depending on the load.

That is, the diaphragm 30 is fixed to the front end of the sub-housing 20 forming a part of the housing and is exposed to a high temperature pressure medium.

The protrusion 32 is formed in a columnar shape extending in the axis S direction toward the inside of the sub-housing 20 from a central region centered on the axis S of the flexible plate-shaped portion 31.

The outer peripheral surface of the protrusion 32 is arranged with an annular gap left between the outer peripheral surface and the inner peripheral wall 22 of the sub-housing 20.

Besides, the protrusion 32 serves to transmit the force received by the flexible plate-shaped portion 31 to the piezoelectric element 72 via the holding plate 40, the heat insulating member 60, and the first electrode 71.

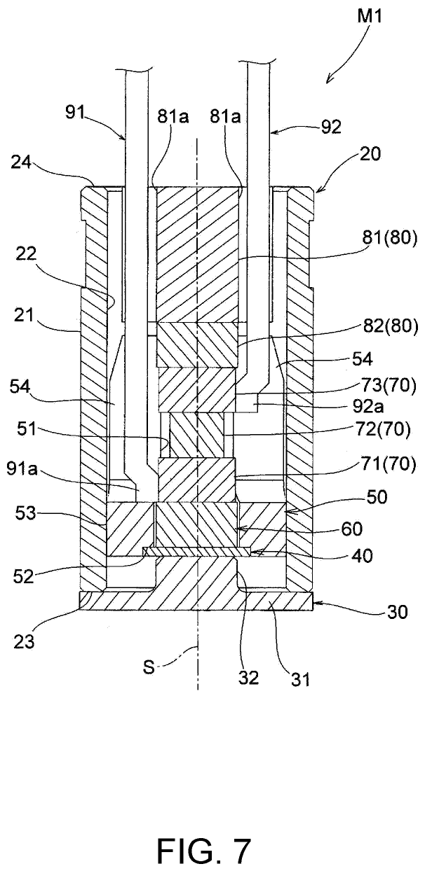

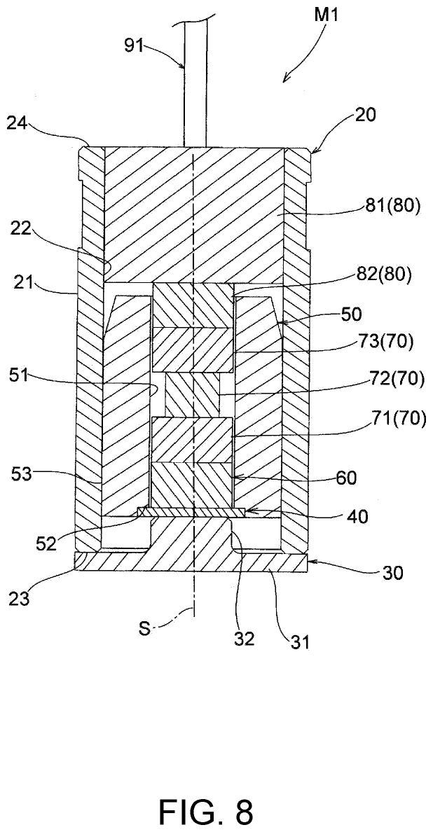

As shown in FIGS. 7 and 8, the holding plate 40 is formed in a disk shape having an outer diameter larger than the outer diameter of the protrusion 32 by using a metal material such as precipitation hardening stainless steel or ferritic stainless steel, an insulating material having high mechanical rigidity, or the like.

Besides, the holding plate 40 is clamped between the protrusion 32 of the diaphragm 30 and the heat insulating member 60, and serves to hold the positioning member 50 to be separated from the flexible plate-shaped portion 31 and define a space between the flexible plate-shaped portion 31 of the diaphragm 30 and the positioning member 50.

As shown in FIG. 7 and FIG. 8, the positioning member 50 is formed in a substantially cylindrical shape extending in the axis S direction by using an insulating material having insulating properties and heat insulating properties, and includes a through hole 51, a fitting recess 52, an outer peripheral surface 53, and two notch grooves 54 for passing the first lead wire 91 and the second lead wire 92 in a non-contact manner.

The through hole 51 is formed as a circular hole centered on the axis S and extending in the axis S direction.

The fitting recess 52 is formed as a circular recess centered on the axis S so as to receive the holding plate 40.

The outer peripheral surface 53 is formed as a cylindrical surface centered on the axis S so as to be fitted to the inner peripheral wall 22 of the sub-housing 20.

The two notch grooves 54 have the same depth dimension in the axis S direction and are arranged at point-symmetrical positions 180 degrees apart around the axis S.

Besides, the positioning member 50 is supported by the holding plate 40 in contact with the protrusion 32 and is fitted to the inner peripheral wall 22 of the sub-housing 20. The positioning member 50 is positioned and held on the axis S in a state that the heat insulating member 60, the pressure measuring member 70 including the first electrode 71, the piezoelectric element 72 and the second electrode 73, and the insulating member 82 are laminated in the through hole 51.

As shown in FIGS. 5, 7 and 8, the heat insulating member 60 is formed in a columnar shape having a predetermined height and an outer diameter equal to the outer diameter of the protrusion 32 and the first electrode 71 by using an insulating material having insulating properties and heat insulating properties.

Besides, inside the sub-housing 20, the heat insulating member 60 is closely arranged between the first electrode 71 and the holding plate 40 which is in contact with the protrusion 32 of the diaphragm 30.

Here, as the insulating material forming the heat insulating member 60, a material having a large heat capacity and a low thermal conductivity is preferable. The thermal conductivity is, for example, preferably 15 W/m·K or less, and more preferably 5 W/m·K or less. Specifically, the material includes, for example, ceramic such as quartz glass, steatite, zirconia, cordierite, forsterite, mullite, and yttria, or a conductive material subjected to an insulating treatment.

That is, the load generated by the pressure received by the diaphragm 30 is transmitted to the piezoelectric element 72 via the holding plate 40, the heat insulating member 60, and the first electrode 71, and heat transfer from the diaphragm 30 to the first electrode 71 is suppressed by the heat insulating member 60. Therefore, the influence of heat on the piezoelectric element 72 adjacent to the first electrode 71 is suppressed, a fluctuation of a reference point (zero point) of a sensor output can be prevented, and a desired sensor precision can be obtained.

The pressure measuring member 70 functions to detect pressure, and includes the first electrode 71, the piezoelectric element 72, and the second electrode 73 which are laminated in sequence from a front end side in the axial S direction inside the sub-housing 20, as shown in FIGS. 5 to 8.

The first electrode 71 is formed in a columnar shape or a disk shape having an outer diameter to be fitted into the through hole 51 of the positioning member 50 by using a conductive metal material such as precipitation hardening stainless steel or ferritic stainless steel. Besides, the first electrode 71 is arranged in the through hole 51 of the positioning member 50 in such a manner that one surface of the first electrode 71 is in close contact with the heat insulating member 60 and the other surface is in close contact with the piezoelectric element 72.

The piezoelectric element 72 is formed in a square columnar shape having a size that prevent the piezoelectric element 72 from being brought into contact with the through hole 51 of the positioning member 50. Besides, the piezoelectric element 72 is arranged in the through hole 51 of the positioning member 50 in such a manner that one surface of the piezoelectric element 72 is in close contact with the first electrode 71, and the other surface of the piezoelectric element 72 is in close contact with the second electrode 73. Accordingly, the piezoelectric element 72 outputs an electric signal based on distortion caused by the load received in the axis S direction.

Moreover, ceramic made of zinc oxide (ZnO), barium titanate (BaTiO₃), lead zirconate titanate (PZT) or the like, quartz, or the like is used as the piezoelectric element 72.

The second electrode 73 is formed in a columnar shape or a disk shape having an outer diameter to be fitted into the through hole 51 of the positioning member 50 by using a conductive metal material such as precipitation hardening stainless steel or ferritic stainless steel. Besides, the second electrode 73 is arranged in the through hole 51 of the positioning member 50 in such a manner that one surface of the second electrode 73 is in close contact with the piezoelectric element 72, and the other surface of the second electrode 73 is in close contact with the insulating member 82.

As shown in FIGS. 5 to 7, the preload applying member 80 includes the fixing member 81 and the insulating member 82, and the preload applying member 80 is arranged inside the sub-housing 20 which forms a part of the housing. The preload applying member 80 plays a role of pressing the pressure measuring member 70 toward the diaphragm 30 to apply a preload and imparting linear characteristics as a sensor to the pressure measuring member 70.

The fixing member 81 is formed, by using a metal material such as precipitation hardening stainless steel or ferritic stainless steel, in a substantially columnar shape having no cavities or hollowed portions in the central region centered on the axis S and occupying an area equal to or larger than the through hole 51. The fixing member 81 has two longitudinal grooves 81a in the outer peripheral region deviating from the central region.

The two longitudinal grooves 81a are each formed by removing the material at point-symmetrical positions 180 degrees apart around the axis S, so that the first lead wire 91 and the second lead wire 92 can pass through in a non-contact manner.

The insulating member 82 is formed in a columnar shape or a disk shape having an outer diameter to be fitted into the through hole 51 of the positioning member 50 by using an insulating material having high electric insulation properties. That is, the insulating member 82 is formed in a solid shape having no cavities or hollowed portions in the entire region occupying the same area as the through hole 51.

Besides, the insulating member 82 functions to maintain the electrical insulation between the second electrode 73 and the fixing member 81 and to guide heat transferred to the piezoelectric element 72 to the fixing member 81 and dissipate the heat.

As the insulating material of the insulating member 82, a material having a small heat capacity and a large thermal conductivity is preferable. Specifically, the material includes, for example, ceramic such as alumina, sapphire, aluminum nitride, and silicon carbide, or a conductive material subjected to an insulating treatment.

In this embodiment, the heat insulating member 60, the first electrode 71, the second electrode 73, and the insulating member 82 are formed to have substantially the same outer diameter dimension and substantially the same thickness, that is, they are formed in substantially the same shape. Moreover, the heat insulating member 60, the first electrode 71, the second electrode 73, and the insulating member 82 need not to be formed in substantially the same shape, and may be appropriately formed into different shapes and dimensions according to required specifications.

As shown in FIG. 7 and FIG. 8, in the assembling of the preload applying member 80, in a state that the pressure measuring member 70 is arranged in the positioning member 50, the insulating member 82 is fitted into the through hole 51 so as to be brought into contact with the second electrode 72. Besides, the pressure measuring member 70 is pressed toward the diaphragm 30 in the axis S direction and is preloaded so that the fixing member 81 is brought into contact with the insulating member 82, and in the above state, the fixing member 81 is fixed to the sub-housing 20 by welding or the like.

Thus, the preload applying member 80 can impart linear characteristics as a sensor to the pressure measuring member 70 by applying a preload.

The first lead wire 91 is a thin wire which is formed by covering a highly weldable wire such as nickel or the like with an insulating material such as fluorine or the like, and is formed in a long size in the axis S direction, as shown in FIG. 2 and FIG. 7.

Besides, the first lead wire 91 has one end portion 91a electrically connected to the first electrode 71 of the pressure measuring member 70 and the other end portion 91b electrically connected to a first terminal 112 of the connector 110, and is electrically connected to the ground side (minus side) with respect to an electric circuit via an external connector.

In addition, the first lead wire 91 is arranged so as to pass through one notch groove 54 of the positioning member 50 and one longitudinal groove 81a of the fixing member 81 in a non-contact manner.

Furthermore, the region between the one end portion 91a and the other end portion 91b of the first lead wire 91 and deviating from the preload applying member 80 is fitted and inserted through the first fitting hole 101 of the restricting member 100.

The second lead wire 92 is a thin wire which is formed by covering a highly weldable wire such as nickel or the like with an insulating material such as fluorine or the like, and is formed in a long size in the axis S direction and has the same outer diameter dimension as the first lead wire 91, as shown in FIG. 2 and FIG. 7.

Besides, the second lead wire 92 has one end portion 92a electrically connected to the second electrode 73 of the pressure measuring member 70 and the other end portion 92b electrically connected to a second terminal 113 of the connector 110, and is electrically connected to an output side (plus side) with respect to an electric circuit via an external connector.

In addition, the second lead wire 92 is arranged so as to pass through the other notch groove 54 of the positioning member 50 and the other longitudinal groove 81a of the fixing member 81 in a non-contact manner.

Furthermore, the region between the one end portion 92a and the other end portion 92b of the first lead wire 92 and deviating from the preload applying member 80 is fitted and inserted through the second fitting hole 102 of the restricting member 100.

The restricting member 100 is formed as a molded rubber having a long columnar shape in the axis S direction by a mold or the like using a rubber material having excellent heat resistance such as silicone rubber or fluororubber.

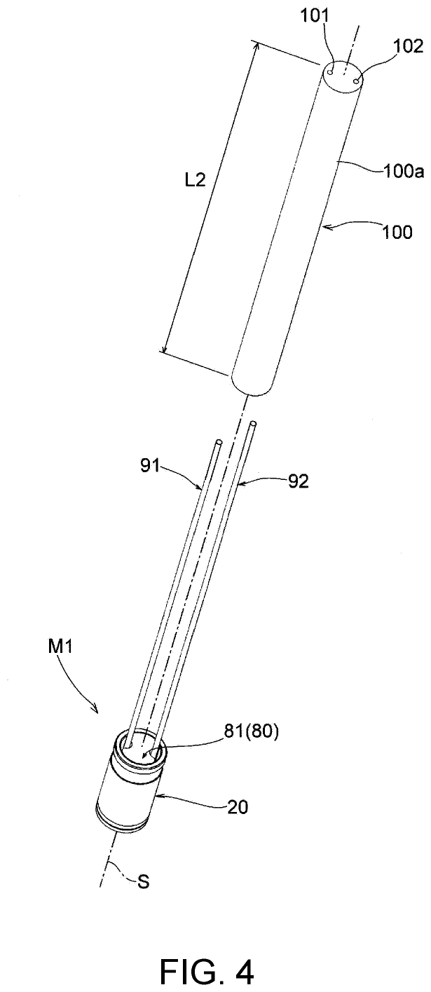

As shown in FIG. 2 and FIG. 4, the restricting member 100 has a length dimension L2 slightly shorter than a length dimension L1 in the axial S direction of the through hole 13 of the outer housing 10, and includes an outer peripheral fitting surface 100a, a first fitting hole 101 and a second fitting hole 102.

Here, as shown in FIG. 2, the length dimension L1 of the through hole 13 is the length in the axial S direction from the step portion 12 to the recessed bottom surface of the connector connecting portion 16 in the outer housing 10. Moreover, the length dimension L2 of the restricting member 100 may be the same as the length dimension L1 of the through hole 13.

The outer peripheral fitting surface 100a is formed to have an outer diameter dimension that allows the outer peripheral fitting surface 100a to be closely fitted, here, press-fitted to the inner wall surface of the through hole 13 of the outer housing 10.

The first fitting hole 101 extends and penetrates in the axis S direction so as to allow the first lead wire 91 to be closely fitted and inserted therethrough.

The second fitting hole 102 extends and penetrates in the axis S direction so as to allow the second lead wire 92 to be closely fitted and inserted therethrough.

Here, the first fitting hole 101 and the second fitting hole 102 are parallel to the axis S and are arranged point symmetrically about the axis S and formed in the same shape. Therefore, the second lead wire 92 may be fitted into the first fitting hole 101, and the first lead wire 91 may be fitted into the second fitting hole 102.

Besides, the restricting member 100 is fitted and fixed to the through hole 13 of the outer housing 10 while being elastically deformed so as to slightly shrink the outer diameter of the outer peripheral fitting surface 100a. The first lead wire 91 is fitted and fixed to the first fitting hole 101 so as to be in close contact with the first fitting hole 101 with no gap therebetween, and the second lead wire 92 is fitted and fixed to the second fitting hole 102 so as to be in close contact with the second fitting hole 102 with no gap therebetween.

As described above, because the restricting member 100 is an elastically deformable molded rubber, the restricting member 100 can be easily fitted even when the inner wall surface of the through hole 13 is not machined.

By arranging the restricting member 100, even when a vibration of the engine is transmitted to the outer housing 10 of the pressure sensor, the vibration is damped by the restricting member 100, a relative movement between the first lead wire 91 and the second lead wire 92 is restricted and a distance therebetween is kept constant.

Therefore, variations in parasitic capacitance between the first lead wire 91 and the second lead wire 92 are prevented. As a result, occurrence of noise due to the variations in parasitic capacitance can be prevented, and a highly precise output signal can thus be obtained.

In addition, the restricting member 100 is arranged in the outer housing 10 in a region deviating from the sub-housing 20 to the inner side in the axis S direction, particularly in a region deviating from the preload applying member 80, and thus can restrict only the relative movement between the first lead wire 91 and the second lead wire 92 without affecting the preload preset by the load applying member 80.

As shown in FIG. 2, the connector 110 includes a coupling portion 111, the first terminal 112, and the second terminal 113.

The coupling portion 111 is coupled to the connector connecting portion 16 located at the rear end of the outer housing 10.

The first terminal 112 is fixed to the coupling portion 111 and electrically connected to the other end portion 91b of the first lead wire 91, and is also electrically connected to a connecting terminal of an external connector.

The second terminal 113 is fixed to the first terminal 112 via an insulating member and electrically connected to the other end portion 92b of the second lead wire 92, and is also electrically connected to a connecting terminal of an external connector.

Next, the assembling work of the pressure sensor having the above configuration is described.

During work, the outer housing 10, the sub-housing 20, the diaphragm 30, the holding plate 40, the positioning member 50, the heat insulating member 60, the first electrode 71, the piezoelectric element 72, the second electrode 73, the fixing member 81, the insulating member 82, the first lead wire 91, the second lead wire 92, the restricting member 100, and the connector 110 are prepared.

First, the diaphragm 30 is fixed to the front end surface 23 of the sub-housing 20 by welding or the like.

Next, the holding plate 40 and the positioning member 50 are fitted into the sub-housing 20. Subsequently, the heat insulating member 60, the first electrode 71 to which the one end portion 91a of the first lead wire 91 is connected, the piezoelectric element 72, the second electrodes 73 to which the one end portion 92a of the second lead wire 92 is connected, and the insulating member 82 are sequentially laminated and fitted inside the positioning member 50.

Moreover, in the subsequent step, the first lead wire 91 may be connected to the first electrode 71, and the second lead wire 92 may be connected to the second electrode 73.

Then, the fixing member 81 is fitted into the sub-housing 20 by pressing the insulating member 82, and is fixed to the sub-housing 20 by welding or the like in a state that a preload is applied. Accordingly, as shown in FIG. 6 and FIG. 7, a sensor module M1 is formed. Moreover, the method of assembling the sensor module M1 is not limited to the above procedure.

Subsequently, the sensor module M1 is assembled into the outer housing 10. That is, the first lead wire 91 and the second lead wire 92 are caused to pass through the through hole 13 of the outer housing 10, and the sub-housing 20 is fitted into the fitting inner peripheral wall 11 of the outer housing 10 to bring the inner-side end surface 24 into contact with the step portion 12.

Then, the sub-housing 20 is fixed to the outer housing 10 by welding.

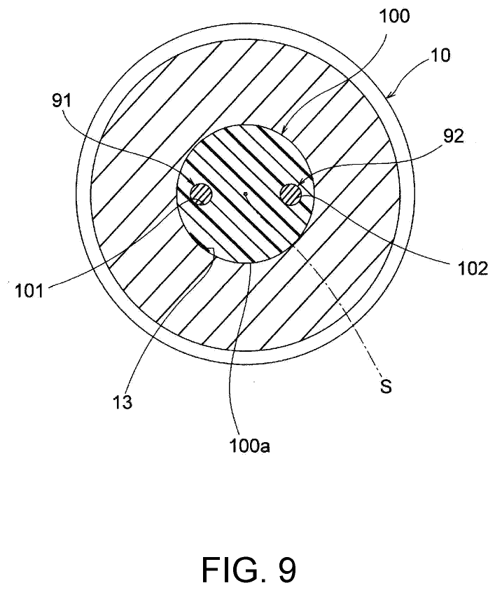

Subsequently, the restricting member 100 is pushed into the through hole 13 of the outer housing 10 through the opening of the connector connecting portion 16, and as shown in FIG. 2 and FIG. 9, the outer peripheral fitting surface 100a is fitted into the through hole 13, the first lead wire 91 is fitted and inserted through the first fitting hole 101 so as to be in close contact with the first fitting hole 101, and the second lead wire 92 is fitted and inserted through the second fitting hole 102 so as to be in close contact with the second fitting hole 102.

During the assembling of the restricting member 100, because the restricting member 100 is made of molded rubber, the restricting member 100 can be pushed in while being elastically deformed, and the assembling work can be smoothly performed.

Subsequently, the other end portion 91b of the first lead wire 91 is bent to a form capable of being coupled to the first terminal 112, and the other end portion 92b of the second lead wire 92 is bent to a form capable of being coupled to the second terminal 113.

Subsequently, the other end portion 91b of the first lead wire 91 is electrically connected to the first terminal 112, the other end portion 92b of the second lead wire 92 is electrically connected to the second terminal 113, and a coupling portion 101 is fixed to the connector connecting portion 16 of the outer housing 10. Accordingly, as shown in FIG. 2, the connector 110 is fixed to the rear end of the outer housing 10. This completes the assembling of the pressure sensor.

Moreover, the above assembling procedure is an example. The assembling procedure is not limited thereto, and other assembling procedures may be adopted.

According to the pressure sensor of the first embodiment, the heat transferred to the diaphragm 30 is insulated by the heat insulating member 60, and the heat transfer from the diaphragm 30 to the first electrode 71 and the piezoelectric element 72 is suppressed. Therefore, the influence of heat on the piezoelectric element 72 is suppressed, a fluctuation of the reference point (zero point) of a sensor output can be prevented, and a desired sensor precision can be obtained.

In addition, the housing includes the outer housing 10 and the sub-housing 20 which is fitted and fixed to the inside of the outer housing 10. The diaphragm 30, the holding plate 40, the positioning member 50, the heat insulating member 60, the pressure measuring member 70, and the preload applying member 80 are arranged on the sub-housing 20.

Accordingly, the diaphragm 30, the holding plate 40, the positioning member 50, the heat insulating member 60, the pressure measuring member 70, and the preload applying member 80 can be preassembled to the sub-housing 20 to form the sensor module M1.

Therefore, when the mounting shape or the like differs depending on the application target, only the outer housing 10 is set for each application target and the sensor module M1 can be shared.

Furthermore, the restricting member 100 restricts the relative movement between the first lead wire 91 and the second lead wire 92 having a long shape in the axis S direction and keeps the distance therebetween constant.

Therefore, the variations in parasitic capacitance between the first lead wire 91 and the second lead wire 92 can be prevented. Thus, the occurrence of noise due to the variations in parasitic capacitance can be prevented, and a highly precise output signal can be obtained.

In addition, because the restricting member 100 is made of molded rubber, the assembling work is facilitated, the vibration transmitted from the engine to the first lead wire 91 and the second lead wire 92 via the outer housing 10 can be reduced or prevented, and a desired electrical connection state can be maintained.

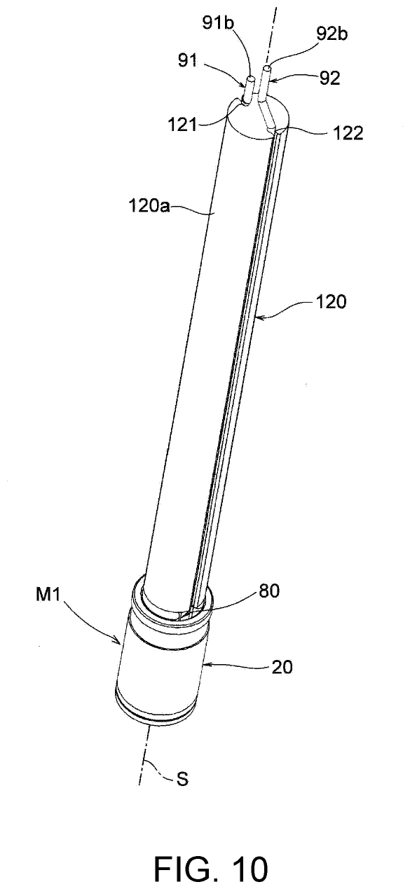

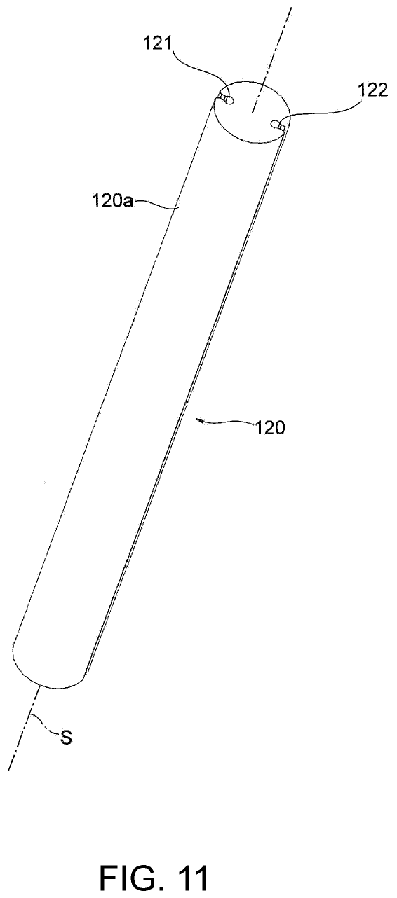

FIGS. 10 to 12 show a first variation example of the restricting member applied to the pressure sensor according to the first embodiment.

A restricting member 120 according to the first variation example is formed as a molded rubber having a long columnar shape in the axis S direction by a mold or the like using the same rubber material as described above.

The restricting member 120 has the same length dimension L2 as described above, and includes an outer peripheral fitting surface 120a, a first fitting groove 111, and a second fitting groove 122.

The outer peripheral fitting surface 120a is formed to have an outer diameter dimension that allows the outer peripheral fitting surface 120a to be closely fitted, here, press-fitted to the inner wall surface of the through hole 13 of the outer housing 10.

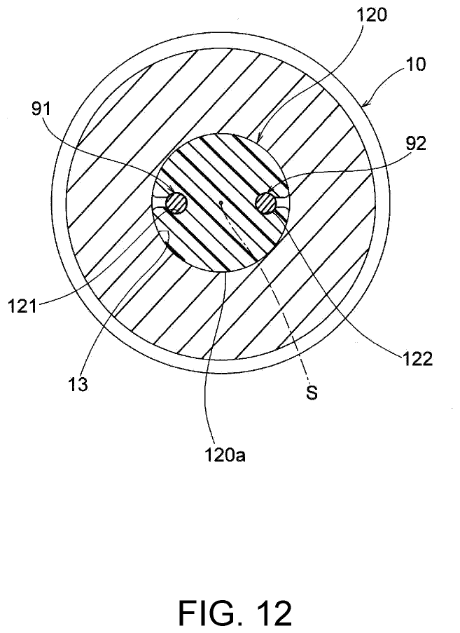

As shown in FIG. 12, the first fitting groove 121 is formed in a cross-sectional shape narrower than the diameter of the portion in which the bottom side of the groove is circular and the opening side is also circular on the plane perpendicular to the axis S, and extends in the axis S direction so as to allow the first lead wire 91 to be closely fitted and inserted therethrough.

Like the first fitting groove 121, the second fitting groove 122 is formed in a cross-sectional shape narrower than the diameter of the portion in which the bottom side of the groove is circular and the opening side is also circular on the plane perpendicular to the axis S, and extends in the axis S direction so as to allow the second lead wire 92 to be closely fitted and inserted therethrough.

Here, the first fitting groove 121 and the second fitting groove 122 are parallel to the axis S and are arranged point symmetrically about the axis S and formed in the same shape. Therefore, the second lead wire 92 may be fitted into the first fitting groove 121, and the first lead wire 91 may be fitted into the second fitting groove 122.

Besides, the restricting member 120 is fitted and fixed to the through hole 13 of the outer housing 10 while being elastically deformed so as to slightly shrink the outer diameter of the outer peripheral fitting surface 120a. The first lead wire 91 is fitted and inserted through the first fitting groove 121 so as to be in close contact with the first fitting groove 121, and the second lead wire 92 is fitted and inserted through the second fitting groove 122 so as to be in close contact with the second fitting groove 122.

As described above, because the restricting member 120 is an elastically deformable molded rubber, the restricting member 120 can be easily fitted even when the inner wall surface of the through hole 13 is not machined.

In addition, because the first fitting groove 121 and the second fitting groove 122 have a higher degree of freedom of elastic deformation and a smaller contact area than the hole shape, when the first lead wire 91 and the second lead wire 92 are fitted to each other, the fitting operation can be smoothly performed, and the assembling work is thus facilitated.

By arranging the restricting member 120, even when a vibration of the engine is transmitted to the outer housing 10 of the pressure sensor, the vibration is damped by the restricting member 120, a relative movement between the first lead wire 91 and the second lead wire 92 is restricted and a distance therebetween is kept constant.

Therefore, the variations in parasitic capacitance between the first lead wire 91 and the second lead wire 92 are prevented. As a result, the occurrence of noise due to the variations in parasitic capacitance can be prevented, and a highly precise output signal can be obtained.

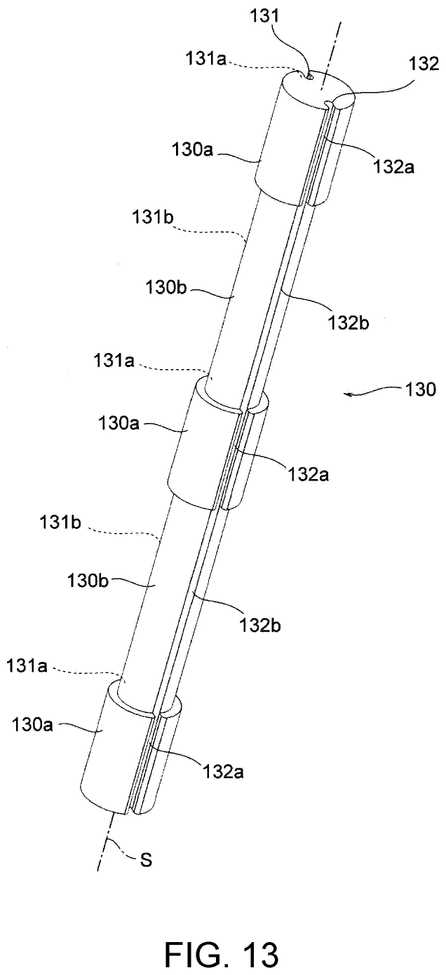

FIG. 13 shows a second variation example of the restricting member applied to the pressure sensor according to the first embodiment.

A restricting member 130 according to the second variation example is formed as a molded rubber having a long multi-stage columnar shape in the axis S direction by a mold or the like using the same rubber material as described above.

The restricting member 130 has the same length dimension L2 as described above, and includes three outer peripheral fitting surfaces 130a, two hollowed portions 130b, a first fitting groove 131, and a second fitting groove 132.

The three outer peripheral fitting surfaces 130a are spaced apart from each other at equal intervals in the axis S direction, and are formed to have an outer diameter dimension that allows the outer peripheral fitting surfaces 130a to be closely fitted, here, press-fitted to the inner wall surface of the through hole 13 of the outer housing 10.

The two hollowed portions 130b are separated from each other in the axis S direction and are arranged among the three outer peripheral fitting surfaces 130a. The two hollowed portions 130b are formed by removing the material so as to form a columnar shape having an outer diameter smaller than that of the outer peripheral fitting surface 130a.

The two hollowed portions 130b are regions that are not in contact with the inner wall surface of the through hole 13 when the restricting member 130 is fitted into the through hole 13 of the outer housing 10.

That is, the restricting member 130 is formed so as to be partially in contact with the inner wall surface of the housing.

The first fitting groove 131 is defined by a fitting groove 131a and a fitting groove 131b, and extends in the axis S direction so as to allow the first lead wire 91 to be closely fitted and inserted therethrough.

In the region of the outer peripheral fitting surface 130a, similar to the form shown in FIG. 12, the fitting groove 131a is formed in a cross-sectional shape narrower than the diameter of the portion in which the bottom side of the groove is circular and the opening side is also circular on the plane perpendicular to the axis S.

In the region of the hollowed portion 130b, the fitting groove 131b is formed in a cross-sectional shape without a narrow region on the opening side as compared with the fitting groove 131a.

The second fitting groove 132 is defined by a fitting groove 132a and a fitting groove 132b, and extends in the axis S direction so as to allow the second lead wire 92 to be closely fitted and inserted therethrough.

In the region of the outer peripheral fitting surface 130a, similar to the form shown in FIG. 12, the fitting groove 132a is formed in a cross-sectional shape narrower than the diameter of the portion in which the bottom side of the groove is circular and the opening side is also circular on the plane perpendicular to the axis S.

In the region of the hollowed portion 130b, the fitting groove 132b is formed in a cross-sectional shape without a narrow region on the opening side as compared with the fitting groove 132a.

Here, the first fitting groove 131 and the second fitting groove 132 are parallel to the axis S and are arranged point symmetrically about the axis S and formed in the same shape. Therefore, the second lead wire 92 may be fitted into the first fitting groove 131, and the first lead wire 91 may be fitted into the second fitting groove 132.

According to the restricting member 130 of the second variation example, the same operational effects as those of the restricting member 120 can be obtained. Besides, when the restricting member 130 is fitted to the outer housing 10, frictional resistance of the portion where the hollowed portion 130b is not in contact with the inner wall surface of the through hole 13 is reduced, and the restricting member 130 can be fitted more smoothly.

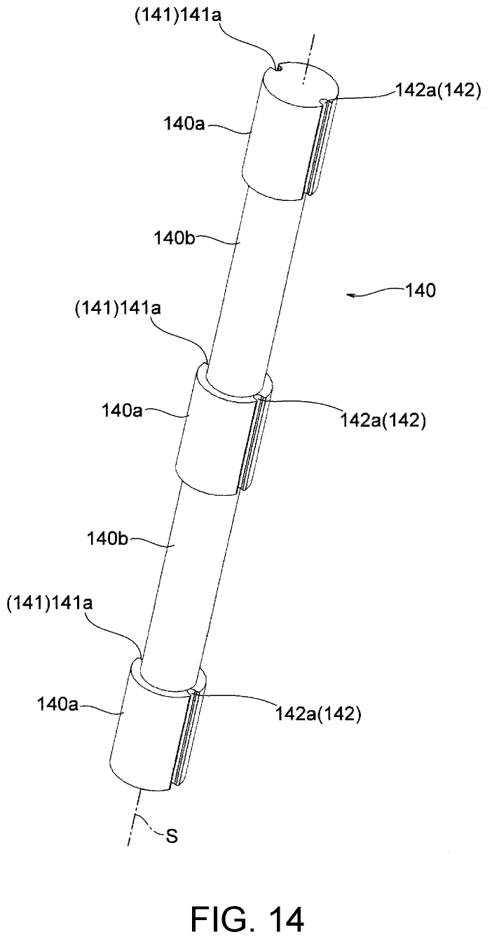

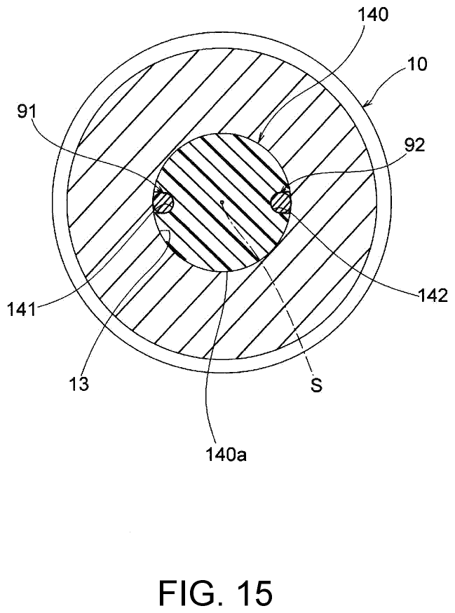

FIG. 14 and FIG. 15 show a third variation example of the restricting member applied to the pressure sensor according to the first embodiment.

A restricting member 140 according to the third variation example is formed as a molded rubber having a long multi-stage columnar shape in the axis S direction by a mold or the like using the same rubber material as described above.

The restricting member 140 has the same length dimension L2 as described above, and includes three outer peripheral fitting surfaces 140a, two hollowed portions 140b, a first fitting groove 141, and a second fitting groove 142.

The three outer peripheral fitting surfaces 140a are spaced apart from each other at equal intervals in the axis S direction, and are formed to have an outer diameter dimension that allows the outer peripheral fitting surfaces 140a to be closely fitted, here, press-fitted to the inner wall surface of the through hole 13 of the outer housing 10.

The two hollowed portions 140b are separated from each other in the axis S direction and are arranged among the three outer peripheral fitting surfaces 140a. The two hollowed portions 140b are formed by removing the material so as to form a columnar shape having an outer diameter smaller than that of the outer peripheral fitting surface 140a.

The two hollowed portions 140b are regions that are not in contact with the inner wall surface of the through hole 13 when the restricting member 140 is fitted into the through hole 13 of the outer housing 10.

That is, the restricting member 140 is formed so as to be partially in contact with the inner wall surface of the housing.

The first fitting groove 141 is defined by three fitting grooves 141a arranged apart from each other in the axis S direction, and extends in the axis S direction so as to allow the first lead wire 91 to be closely fitted and inserted therethrough.

As shown in FIG. 15, in the region of the outer peripheral fitting surface 140a, the fitting groove 141a is formed in a substantially semicircular cross-sectional shape on the plane perpendicular to the axis S.

The second fitting groove 142 is defined by three fitting grooves 142a arranged apart from each other in the axis S direction, and extends in the axis S direction so as to allow the second lead wire 92 to be closely fitted and inserted therethrough.

As shown in FIG. 15, in the region of the outer peripheral fitting surface 140a, the fitting groove 142a is formed in a substantially semicircular cross-sectional shape on the plane perpendicular to the axis S.

Here, the first fitting groove 141 and the second fitting groove 142 are parallel to the axis S and are arranged point symmetrically about the axis S and formed in the same shape. Therefore, the second lead wire 92 may be fitted into the first fitting groove 141, and the first lead wire 91 may be fitted into the second fitting groove 142.

According to the restricting member 140 of the third variation example, the same operational effects as those of the restricting member 120 can be obtained. Besides, when the restricting member 140 is fitted to the outer housing 10, frictional resistance of the portion where the hollowed portion 140b is not in contact with the inner wall surface of the through hole 13 is reduced, and the restricting member 140 can be fitted more smoothly.

In addition, the first fitting groove 141 and the second fitting groove 142 have a substantially semicircular cross section, the first lead wire 91 is held and fixed between the first fitting groove 141 and the inner wall surface of the through hole 13, and the second lead wire 92 is held and fixed between the second fitting groove 142 and the inner wall surface of the through hole 13, and thus the fitting operation of the restricting member 140 can be performed more smoothly.

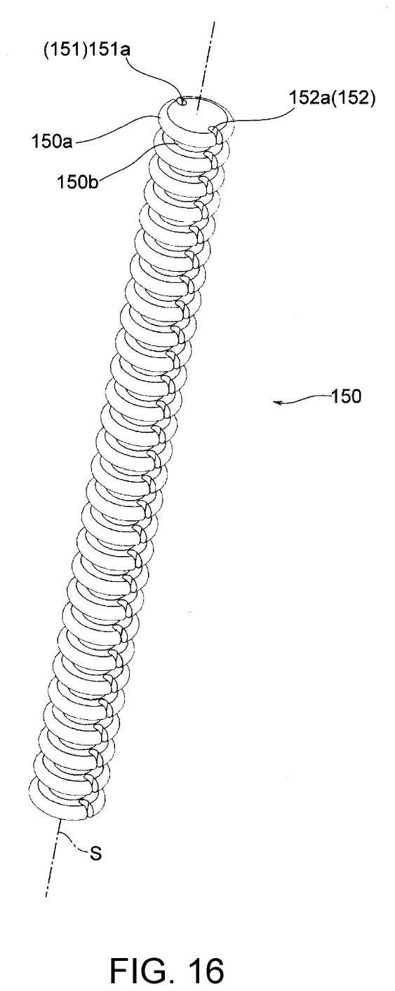

FIG. 16 shows a fourth variation example of the restricting member applied to the pressure sensor according to the first embodiment.

A restricting member 150 according to the fourth variation example is formed as a molded rubber having a long multi-stage columnar shape in the axis S direction by a mold or the like using the same rubber material as described above.

The restricting member 150 has the same length dimension L2 as described above, and includes a plurality of annular fitting portions 150a, a plurality of hollowed portions 150b, a first fitting groove 151, and a second fitting groove 152.

The plurality of annular fitting portions 150a are spaced apart from each other at equal intervals in the axis S direction, and are formed to have an outer diameter dimension that allows the annular fitting portions 150a to be closely fitted, here, press-fitted to the inner wall surface of the through hole 13 of the outer housing 10.

The plurality of hollowed portions 150b are separated from each other at equal intervals in the axial S direction and are arranged among the plurality of annular fitting portions 150a. The plurality of hollowed portions 150b are formed by removing the material so as to form a columnar shape having an outer diameter smaller than that of the annular fitting portions 150a.

The plurality of hollowed portions 150b are regions that are not in contact with the inner wall surface of the through hole 13 when the restricting member 150 is fitted into the through hole 13 of the outer housing 10.

That is, the restricting member 150 is formed so as to be partially in contact with the inner wall surface of the housing.

The first fitting groove 151 is defined by a plurality of fitting grooves 151a arranged apart from each other in the axis S direction, and extends in the axis S direction so as to allow the first lead wire 91 to be closely fitted and inserted therethrough.

In the region of the annular fitting portion 150a, similar to the form shown in FIG. 12, the fitting groove 151a is formed in a cross-sectional shape narrower than the diameter of the portion in which the bottom side of the groove is circular and the opening side is also circular on the plane perpendicular to the axis S.

The second fitting groove 152 is defined by a plurality of fitting grooves 152a arranged apart from each other in the axis S direction, and extends in the axis S direction so as to allow the second lead wire 92 to be closely fitted and inserted therethrough.

In the region of the annular fitting portion 150a, similar to the form shown in FIG. 12, the fitting groove 152a is formed in a cross-sectional shape narrower than the diameter of the portion in which the bottom side of the groove is circular and the opening side is also circular on the plane perpendicular to the axis S.

Here, the first fitting groove 151 and the second fitting groove 152 are parallel to the axis S and are arranged point symmetrically about the axis S and formed in the same shape. Therefore, the second lead wire 92 may be fitted into the first fitting groove 151, and the first lead wire 91 may be fitted into the second fitting groove 152.

According to the restricting member 150 of the fourth variation example, the same operational effects as those of the restricting member 120 can be obtained. Besides, when the restricting member 150 is fitted to the outer housing 10, frictional resistance of the portion where the hollowed portion 150b is not in contact with the inner wall surface of the through hole 13 is reduced, and the restricting member 150 can be fitted more smoothly.

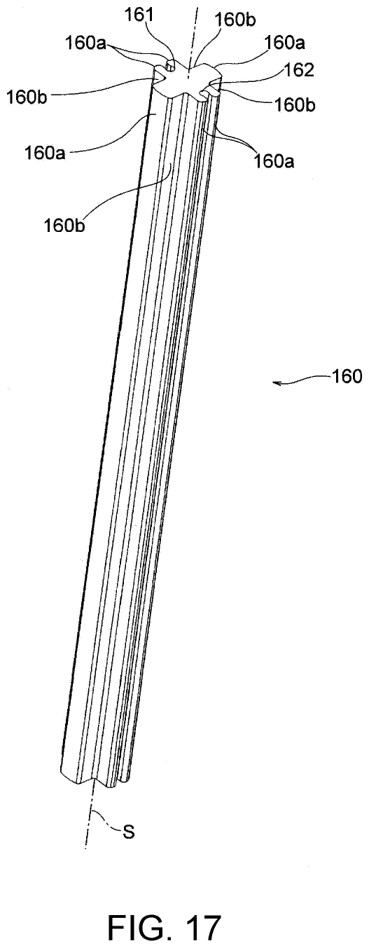

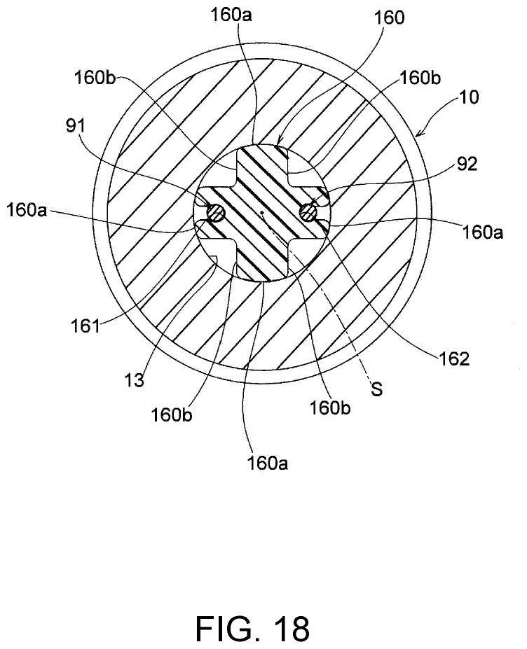

FIG. 17 and FIG. 18 show a fifth variation example of the restricting member applied to the pressure sensor according to the first embodiment.

A restricting member 160 according to the fifth variation example is formed as a molded rubber by a mold or the like using the same rubber material as described above, and the molded rubber is formed in a long columnar shape having a substantially cruciform section in the axis S direction.

The restricting member 160 has the same length dimension L2 as described above, and includes four outer peripheral fitting surfaces 160a, four hollowed portions 160b, a first fitting groove 161, and a second fitting groove 162.

In order to define a part of the columnar outer peripheral surface, the four outer peripheral fitting surfaces 160a are spaced apart from each other at equal intervals in the axis S direction, and are formed to have an outer diameter dimension that allows the outer peripheral fitting surfaces 160a to be closely fitted, here, press-fitted to the inner wall surface of the through hole 13 of the outer housing 10.

The four hollowed portions 160b are spaced apart at equal intervals around the axis S and are arranged among the four outer peripheral fitting surfaces 160a. The four hollowed portions 160b are formed by removing the material so as to form a fan-shaped cross section having a central angle of about 90 degrees and extend in the axis S direction.

The four hollowed portions 160b are regions that are not in contact with the inner wall surface of the through hole 13 when the restricting member 160 is fitted into the through hole 13 of the outer housing 10.

That is, the restricting member 160 is formed so as to be partially in contact with the inner wall surface of the housing.

As shown in FIG. 18, on the outer peripheral fitting surface 160a, the first fitting groove 161 is formed in a cross-sectional shape narrower than the diameter of the portion in which the bottom side of the groove is circular and the opening side is also circular on the plane perpendicular to the axis S, and extends in the axis S direction so as to allow the first lead wire 91 to be closely fitted and inserted therethrough.

Similar to the first fitting groove 161, on the outer peripheral fitting surface 160a, the second fitting groove 162 is formed in a cross-sectional shape narrower than the diameter of the portion in which the bottom side of the groove is circular and the opening side is also circular on the plane perpendicular to the axis S, and extends in the axis S direction so as to allow the second lead wire 92 to be closely fitted and inserted therethrough.

Here, the first fitting groove 161 and the second fitting groove 162 are parallel to the axis S and are arranged point symmetrically about the axis S and formed in the same shape. Therefore, the second lead wire 92 may be fitted into the first fitting groove 161, and the first lead wire 91 may be fitted into the second fitting groove 162.

According to the restricting member 160 of the fifth variation example, the same operational effects as those of the restricting member 120 can be obtained. Besides, when the restricting member 160 is fitted to the outer housing 10, frictional resistance of the portion where the hollowed portion 160b is not in contact with the inner wall surface of the through hole 13 is reduced, and the restricting member 160 can be fitted more smoothly.

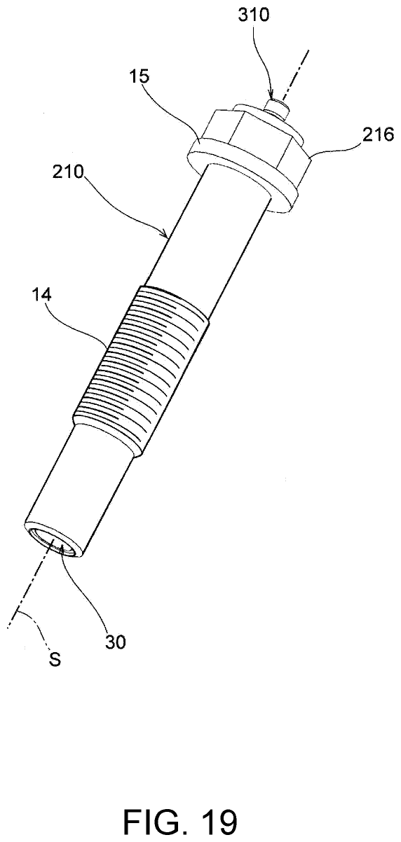

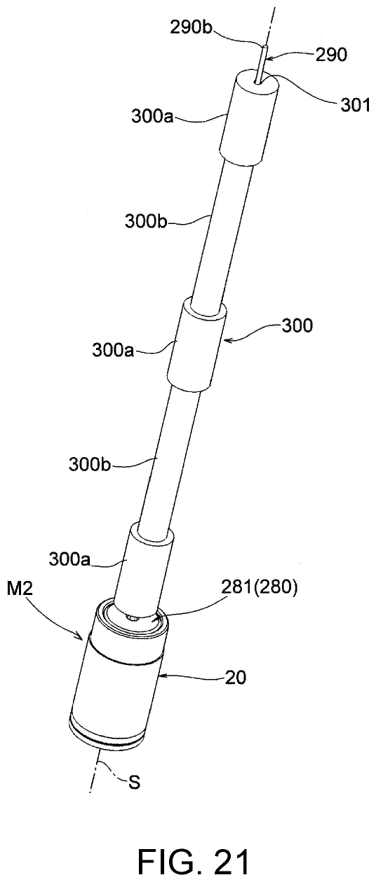

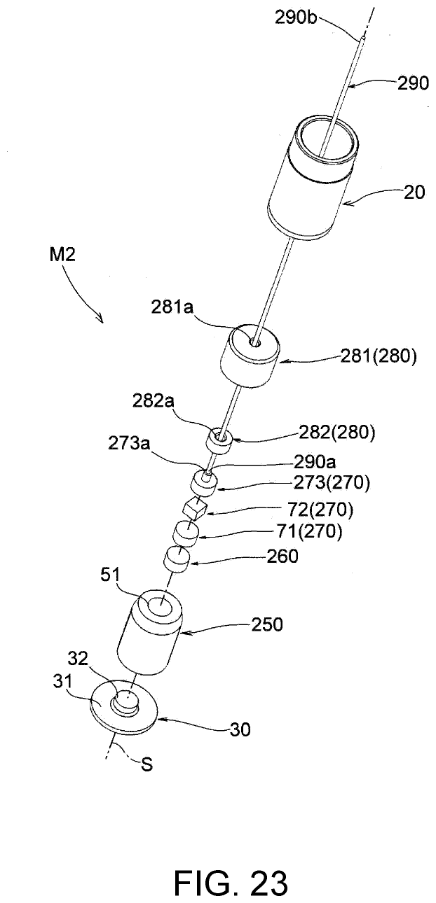

FIGS. 19 to 26 show a second embodiment of the pressure sensor according to the present invention. The same configuration as the pressure sensor according to the first embodiment are designated by the same reference signs, and the description thereof is omitted.

The pressure sensor according to the second embodiment includes an outer housing 210 and a sub-housing 20 being cylindrical housings, the diaphragm 30, a positioning member 250, a heat insulating member 260, a pressure measuring member 270, a preload applying member 280, a lead wire 290 serving as a second conductor, a restricting member 300, and a connector 310.

The pressure measuring member 270 includes the first electrode 71, the piezoelectric element 72, and the second electrode 273 which are laminated in sequence from the front end side of the housing in the axis S direction.

The preload applying member 280 includes a fixing member 281 and an insulating member 282.

The outer housing 210 also serves as the first conductor, and is formed in a cylindrical shape extending in the axis S direction by using a metal material such as precipitation hardening stainless steel or ferritic stainless steel. The outer housing 210 includes the fitting inner peripheral wall 11 located at the front end side, the stepped portion 12, the through hole 13, the male screw portion 14, the flange portion 15, and a connector connecting portion 216 located at the rear end.

The connector connecting portion 216 is formed so as to connect the connector 310.

The positioning member 250 is formed in a substantially cylindrical shape extending in the axis S direction by using an insulating material having the same insulating properties and heat insulating properties as the positioning member 50. The positioning member 250 includes the cylindrical through hole 51 centered on the axis S, the cylindrical outer peripheral surface 53, and an annular end surface 252 which is in contact with a flexible flat plate portion 31 of the diaphragm 30.

Besides, the positioning member 250 is fitted to the inner peripheral wall 22 of the sub-housing 20, and positioned and held on the axis S in a state that the protrusion 32 of the diaphragm 30, the heat insulating member 260, the pressure measuring member 270 including the first electrode 71, the piezoelectric element 72 and the second electrode 273, and the insulating member 282 are laminated in the through hole 51.

In addition, the thermal conductivity of the positioning member 250 is preferably equal to the thermal conductivity of the heat insulating member 260 and smaller than the thermal conductivity of the insulating member 282. Accordingly, the positioning member 250 can also function as a heat insulating member.

Furthermore, because the positioning member 250 is formed so as to surround the heat insulating member 260 and the pressure measuring member 270, heat transfer from the diaphragm 30 and the wall portion of the housing toward the piezoelectric element 72 can be suppressed more efficiently.

The heat insulating member 260 has electrical conductivity and heat insulating properties, and is formed in a columnar shape having a predetermined height and an outer diameter equal to the outer diameter of the protrusion 32 and the first electrode 71.

Here, the heat insulating member 260 preferably has a large heat capacity and a low thermal conductivity. The thermal conductivity is, for example, preferably 15 W/m·K or less, and more preferably 5 W/m·K or less. Specifically, the material of the heat insulating member 260 includes, for example, an insulating material having a conductive film in which a conductive thin film is arranged on the surface of a member such as ceramics formed of a low thermal conductivity material, an insulation conductive material having a layered structure in which silicon layers and germanium layers are arranged alternately, other insulation conductive materials, and the like.

Besides, inside the sub-housing 20, the heat insulating member 260 is closely arranged between the protrusion 32 of the diaphragm 30 and the first electrode 71.

Accordingly, the heat insulating member 260 electrically connects the first electrode 71 to the housings (the outer housing 210 and the sub-housing 20) serving as the first conductor via the diaphragm 30, and functions to suppress the heat transfer from the diaphragm 30 to the first electrode 71.

The pressure measuring member 270 functions to detect pressure, and includes the first electrode 71, the piezoelectric element 72, and the second electrodes 273 which are laminated in sequence from a front end side in the axial S direction inside the sub-housing 20.

In the through hole 51 of the positioning member 250, the first electrode 71 is arranged in such a manner that one surface of the first electrode 71 is in close contact with the heat insulating member 260 and the other surface is in close contact with the piezoelectric element 72.

Besides, the first electrode 71 is connected to the ground side (minus side) with respect to an electric circuit via the heat insulating member 260, the diaphragm 30, and the housings (the outer housing 210 and the sub-housing 20) that also serve as the first conductor.

The second electrode 273 is formed in a columnar shape or a disk shape having an outer diameter to be fitted into the through hole 51 of the positioning member 250 by using a conductive metal material such as precipitation hardening stainless steel or ferritic stainless steel, and includes a cylindrical connecting portion 273a that connects one end portion 290a of the lead wire 290 on one end surface.

Besides, in the through hole 51 of the positioning member 250, the second electrode 273 is arranged in such a manner that one surface is in close contact with the piezoelectric element 72 and the other surface is in close contact with the insulating member 282.

The preload applying member 280 includes the fixing member 281 and the insulating member 282, and the preload applying member 280 is arranged inside the sub-housing 20 which forms a part of the housing. The preload applying member 280 plays a role of pressing the pressure measuring member 270 toward the diaphragm 30 to apply a preload and imparting linear characteristics as a sensor to the pressure measuring member 270.

The fixing member 281 is formed in a substantially columnar shape by using a metal material such as precipitation hardening stainless steel or ferritic stainless steel, and includes a through hole 281a for passing the lead wire 290 in a non-contact manner in the central region centered on the axis S.

The insulating member 282 is formed in a columnar shape or a disk shape having an outer diameter to be fitted into the through hole 51 of the positioning member 250 by using an insulating material having high electric insulation properties, and includes a through hole 282a for passing the connecting portion 273a of the second electrode 273 and the lead wire 290 in the central region centered on the axis S.

The insulating material of the insulating member 282 preferably has a small heat capacity and a large thermal conductivity. Specifically, the material includes, for example, ceramic such as alumina, sapphire, aluminum nitride, and silicon carbide, or a conductive material subjected to an insulating treatment.

In addition, the insulating member 282 preferably has a thermal conductivity larger than that of the heat insulating member 260, for example, 30 W/m·K or more. In addition, the insulating member 282 preferably has a heat capacity smaller than that of the heat insulating member 260. Accordingly, the amount of heat transferred to the piezoelectric element 72 by the heat insulating member 260 can be suppressed as much as possible, and the dissipation of the heat transferred to the piezoelectric element 72 can be promoted through the insulating member 282.

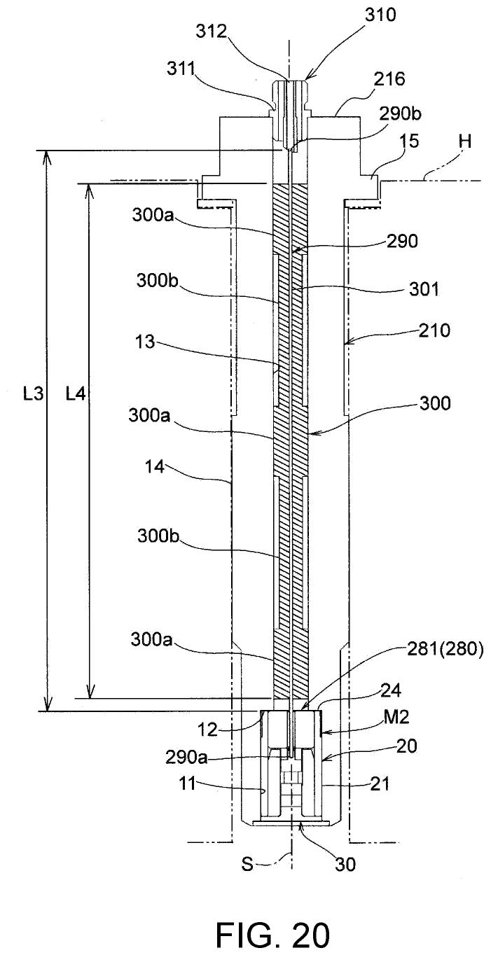

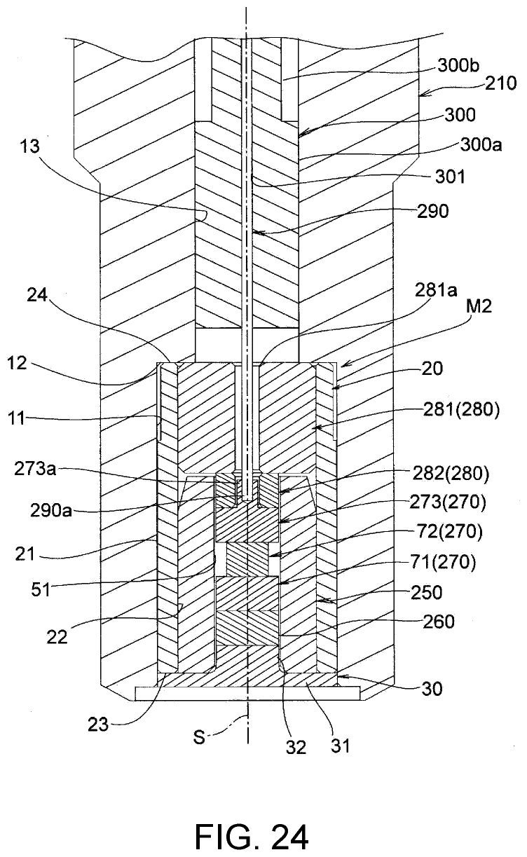

As shown in FIG. 20 and FIG. 24, the lead wire 290 is a thin wire which is formed by covering a highly weldable lead wire such as nickel with a fluorine-based insulating material or the like, and is formed in a long size in the axis S direction.

Besides, the lead wire 290 has the one end portion 290a electrically connected to the second electrode 273 of the pressure measuring member 270 and the other end portion 290b electrically connected to a terminal 312 of the connector 310, and is electrically connected to the output side (plus side) of an electric circuit via an external connector.

In addition, the lead wire 290 is arranged so as to pass through the through hole 281a of the fixing member 280 in a non-contact manner.

Furthermore, the region between the one end portion 290a and the other end portion 290b of the lead wire 290 and deviating from the preload applying member 280 is fitted and inserted through a fitting hole 301 of the restricting member 300.

The restricting member 300 is formed as a molded rubber having a long multi-stage columnar shape in the axis S direction by a mold or the like using the same rubber material as described above.

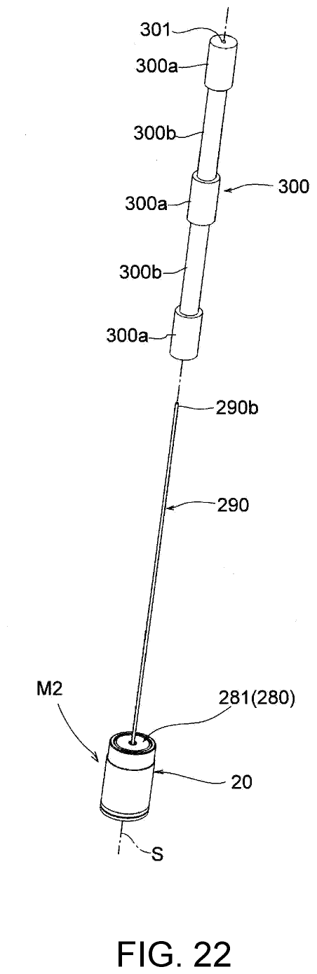

As shown in FIG. 20 and FIG. 22, the restricting member 300 has a length dimension L4 shorter than the length dimension L3 in the axial S direction of the through hole 13 of the outer housing 210, and includes three outer peripheral fitting surfaces 300a, two hollowed portions 300b and a fitting hole 301.

Here, as shown in FIG. 20, the length dimension L3 of the through hole 13 is a length in the axis S direction from the step portion 12 to the inside end portion of the terminal 312 of the connector 310 connected to the connector connecting portion 216 in the outer housing 10. Moreover, the length dimension L4 of the restricting member 300 may be the same as the length dimension L3 of the through hole 13.

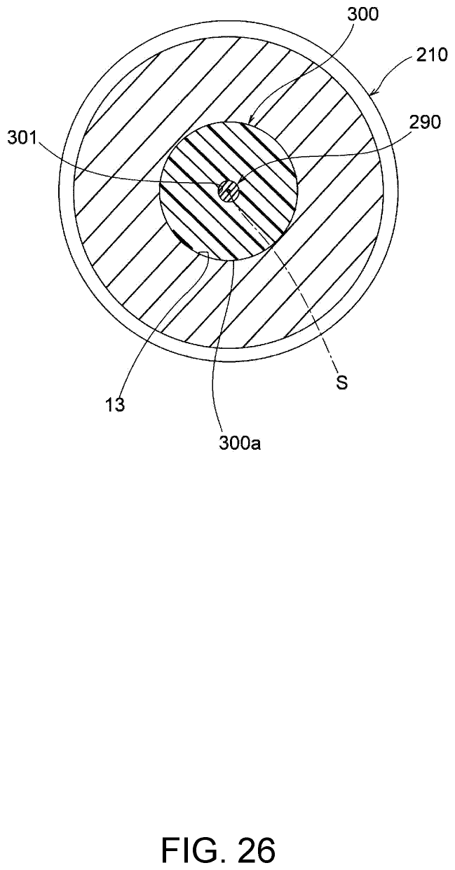

As shown in FIG. 26, the three outer peripheral fitting surfaces 300a are spaced apart from each other at equal intervals in the axis S direction, and are formed to have an outer diameter dimension that allows the outer peripheral fitting surfaces 300a to be closely fitted, here, press-fitted to the inner wall surface of the through hole 13 of the outer housing 210.

The two hollowed portions 300b are separated from each other in the axis S direction and are arranged among the three outer peripheral fitting surfaces 300a. The two hollowed portions 300b are formed by removing the material so as to form a columnar shape having an outer diameter smaller than that of the outer peripheral fitting surface 300a.

The two hollowed portions 300b are regions that are not in contact with the inner wall surface of the through hole 13 when the restricting member 300 is fitted into the through hole 13 of the outer housing 210.

That is, the restricting member 300 is formed so as to be partially in contact with the inner wall surface of the housing.

The fitting hole 301 is arranged coaxially with the axis S and extends to penetrate in the axis S direction so as to allow the lead wire 290 to be closely fitted and inserted therethrough.

Besides, the restricting member 300 is fitted and fixed to the through hole 13 of the outer housing 210 while being elastically deformed so as to slightly shrink the outer diameter of the outer peripheral fitting surface 300a, and the lead wire 290 is closely fitted and fixed to the fitting hole 301 without a gap left therebetween.

As described above, because the restricting member 300 is an elastically deformable molded rubber, the restricting member 300 can be easily fitted even when the inner wall surface of the through hole 13 is not machined.

By arranging the restricting member 300, even when a vibration of the engine is transmitted to the outer housing 210 of the pressure sensor, the vibration is damped by the restricting member 300, a relative movement between the outer housing 210 and the lead wire 290 is restricted and a distance therebetween is kept constant.

Therefore, variations in parasitic capacitance between the outer housing 210 and the lead wire 290 are prevented. As a result, occurrence of noise due to the variations in parasitic capacitance can be prevented, and a highly precise output signal can thus be obtained.

In addition, the restricting member 300 is arranged in the outer housing 210 in a region deviating from the sub-housing 20 to the inner side in the axis S direction, particularly in a region deviating from the preload applying member 280, and thus can restrict only the relative movement of the lead wire 290 with respect to the outer housing 210 without affecting the preload preset by the preload applying member 280.

As shown in FIG. 20, the connector 310 includes a coupling portion 311 and a terminal 312.

The coupling portion 311 is coupled to the connector connecting portion 216 located at the rear end of the outer housing 210.

The terminal 312 is fixed to the coupling portion 311 via an insulating member and electrically connected to the other end portion 290b of the lead wire 290, and is also electrically connected to a connecting terminal of an external connector.

Next, the assembling work of the pressure sensor having the above configuration is described.

During work, the outer housing 210, the sub-housing 20, the diaphragm 30, the positioning member 250, the heat insulating member 260, the first electrode 71, the piezoelectric element 72, the second electrode 273, the fixing member 281, the insulating member 282, the lead wire 290, the restricting member 300 and the connector 310 are prepared.

First, the diaphragm 30 is fixed to the front end surface 23 of the sub-housing 20 by welding or the like.

Next, the positioning member 250 is fitted into the sub-housing 20. Subsequently, the heat insulating member 260, the first electrode 71, the piezoelectric element 72, the second electrode 273 to which the one end portion 290a of the lead wire 290 is connected, and the insulating member 282 are sequentially laminated and fitted inside the positioning member 250. Moreover, the lead wire 290 may be connected to the second electrode 273 in the subsequent step.

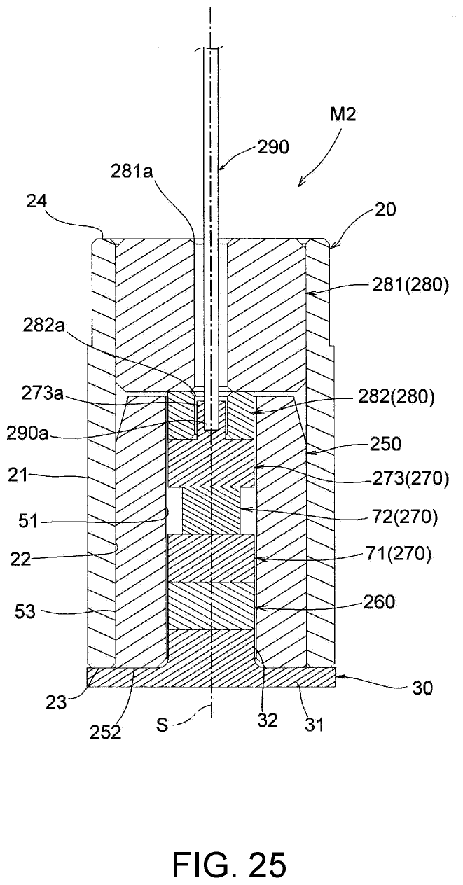

Then, the fixing member 281 is fitted into the sub-housing 20 by pressing the insulating member 282, and is fixed to the sub-housing 20 by welding or the like in a state that a preload is applied. Accordingly, as shown in FIG. 24 and FIG. 25, a sensor module M2 is formed. Moreover, the method of assembling the sensor module M2 is not limited to the above procedure.

Subsequently, the sensor module M2 is assembled into the outer housing 210. That is, the lead wire 290 is caused to pass through the through hole 13 of the outer housing 210, and the sub-housing 20 is fitted into the fitting inner peripheral wall 11 of the outer housing 210 to bring the inner-side end surface 24 into contact with the step portion 12.

Then, the sub-housing 20 is fixed to the outer housing 210 by welding.

Subsequently, the restricting member 300 is pushed into the through hole 13 of the outer housing 210 through the opening of the connector connecting portion 216, and as shown in FIG. 20 and FIG. 26, the outer peripheral fitting surface 300a is fitted into the through hole 13, and the lead wire 290 is fitted and inserted through the fitting hole 301 so as to be in close contact with the fitting hole 301.

During the assembling of the restricting member 300, because the restricting member 300 is made of molded rubber, the restricting member 300 can be pushed in while being elastically deformed, and the assembling work can be smoothly performed.

Subsequently, the other end portion 290b of the lead wire 290 is electrically connected to the terminal 312, and the coupling portion 311 is fixed to the connector connecting portion 216 of the outer housing 210. Accordingly, as shown in FIG. 20, the connector 310 is fixed to the rear end of the outer housing 210. This completes the assembling of the pressure sensor.

Moreover, the above assembling procedure is an example. The assembling procedure is not limited thereto, and other assembling procedures may be adopted.

According to the pressure sensor of the second embodiment, the heat transferred to the diaphragm 30 is insulated by the heat insulating member 260, and the heat transfer from the diaphragm 30 to the first electrode 71 and the piezoelectric element 72 is suppressed. Therefore, the influence of heat on the piezoelectric element 72 is suppressed, a fluctuation of the reference point (zero point) of a sensor output can be prevented, and a desired sensor precision can be obtained.

In addition, the housing includes the outer housing 210 and the sub-housing 20 which is fitted and fixed to the inside of the outer housing 210. The diaphragm 30, the positioning member 250, the heat insulating member 260, the pressure measuring member 270 and the preload applying member 280 are arranged on the sub-housing 20.

Accordingly, the diaphragm 30, the positioning member 250, the heat insulating member 260, the pressure measuring member 270, and the preload applying member 280 can be preassembled to the sub-housing 20 to form the sensor module M2.

Therefore, when the mounting shape or the like differs depending on the application target, only the outer housing 210 is set for each application target and the sensor module M2 can be shared.

Furthermore, the restricting member 300 restricts the relative movement between the lead wire 290 and the outer housing 210, which has a long shape in the axis S direction and also serves as the first conductor, and keeps the distance therebetween constant.

Consequently, variations in parasitic capacitance between the outer housing 210 and the lead wire 290 can be prevented. Therefore, occurrence of noise due to the variations in parasitic capacitance can be prevented, and a highly precise output signal can be obtained.

In addition, because the restricting member 300 is made of molded rubber, the assembling work is facilitated, the vibration transmitted from the engine to the lead wire 290 via the outer housing 210 can be reduced or prevented, and a desired electrical connection state can be maintained.

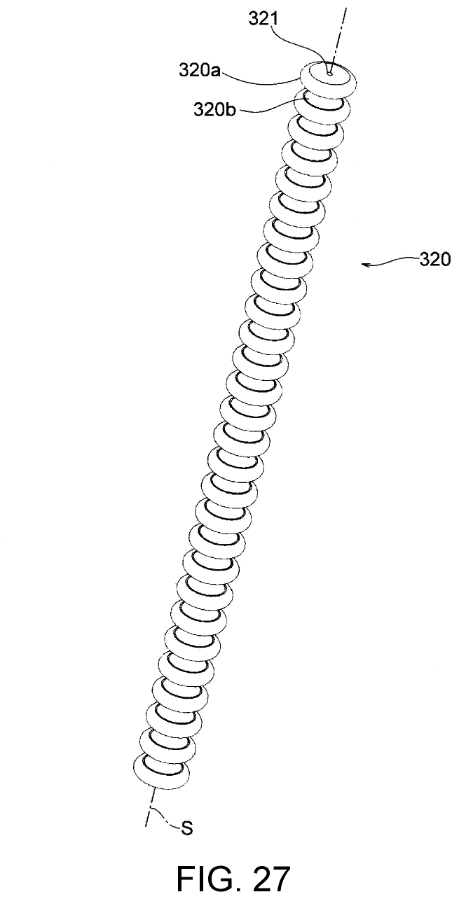

FIG. 27 shows a first variation example of the restricting member applied to the pressure sensor according to the second embodiment.

A restricting member 320 according to the first variation example is formed as a molded rubber having a long multi-stage columnar shape in the axis S direction by a mold or the like using the same rubber material as described above.

The restricting member 320 has the same length dimension L4 as described above, and includes a plurality of annular fitting portions 320a, a plurality of hollowed portions 320b, and a fitting hole 321.

The plurality of annular fitting portions 320a are spaced apart from each other at equal intervals in the axis S direction, and are formed to have an outer diameter dimension that allows the annular fitting portions 320a to be closely fitted, here, press-fitted to the inner wall surface of the through hole 13 of the outer housing 210.

The plurality of hollowed portions 320b are separated from each other at equal intervals in the axis S direction and are arranged among the plurality of annular fitting portions 320a. The plurality of hollowed portions 320b are formed by removing the material so as to form a columnar shape having an outer diameter smaller than that of the annular fitting portions 320a.

The plurality of hollowed portions 320b are regions that are not in contact with the inner wall surface of the through hole 13 when the restricting member 320 is fitted into the through hole 13 of the outer housing 210.

That is, the restricting member 320 is formed so as to be partially in contact with the inner wall surface of the housing.

The fitting hole 321 is arranged coaxially with the axis S and extends to penetrate in the axis S direction so as to allow the lead wire 290 to be closely fitted and inserted therethrough.

According to the restricting member 320 of the first variation example, the same operational effects as those of the restricting member 300 can be obtained.

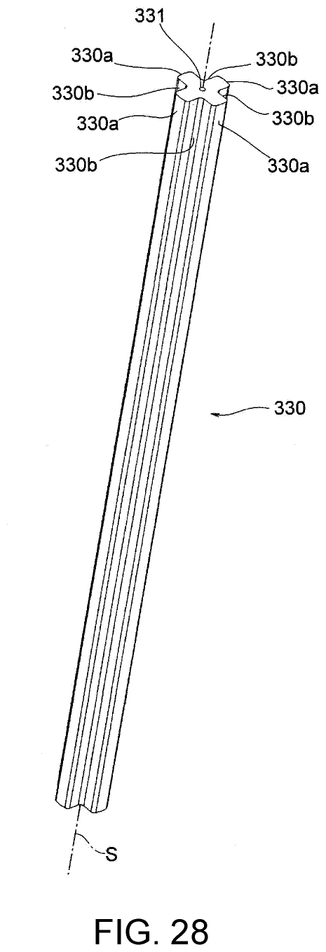

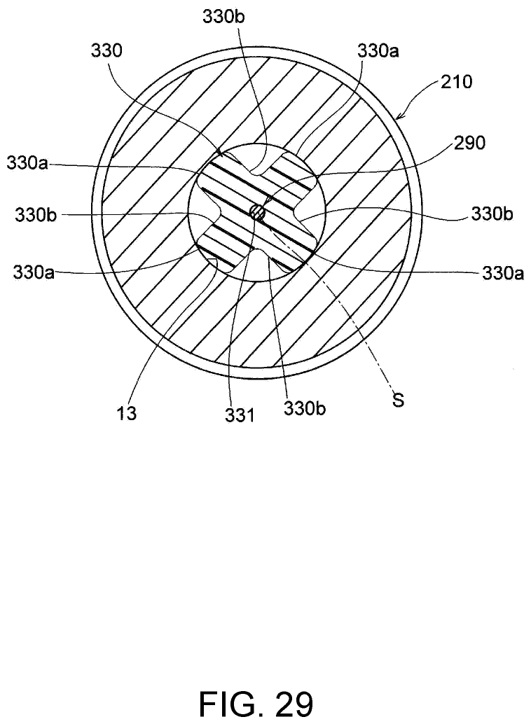

FIG. 28 and FIG. 29 show a second variation example of the restricting member applied to the pressure sensor according to the second embodiment.

The restricting member 330 according to the second variation example is formed as a molded rubber by a mold or the like using the same rubber material as described above, and the molded rubber is formed in a long columnar shape having a substantially cruciform section in the axis S direction.

The restricting member 330 has the same length dimension L4 as described above, and includes four outer peripheral fitting surfaces 330a, four hollowed portions 330b, and a fitting hole 331.

The four outer peripheral fitting surfaces 330a are spaced apart from each other at equal intervals around the axis S so as to define a part of the columnar outer peripheral surface, and are formed to have an outer diameter dimension that allows the outer peripheral fitting surfaces 330a to be closely fitted, here, press-fitted to the inner wall surface of the through hole 13 of the outer housing 210.

As shown in FIG. 29, the four hollowed portions 330b are spaced apart from each other at equal intervals around the axis S and are arranged among the four outer peripheral fitting surfaces 330a. The four hollowed portions 330b are formed by removing the material so as to form a fan-shaped cross section having a central angle of about 90 degrees and extend in the axis S direction.

The four hollowed portions 330b are regions that are not in contact with the inner wall surface of the through hole 13 when the restricting member 330 is fitted into the through hole 13 of the outer housing 210.

That is, the restricting member 330 is formed so as to be partially in contact with the inner wall surface of the housing.

The fitting hole 331 is arranged coaxially with the axis S and extends to penetrate in the axis S direction so as to allow the lead wire 290 to be closely fitted and inserted therethrough.

According to the restricting member 330 of the second variation example, the same operational effects as those of the restricting members 300 and 310 can be obtained.

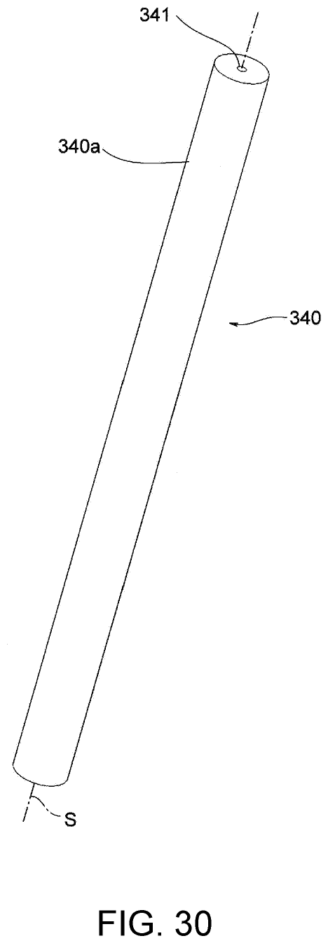

FIG. 30 shows a third variation example of the restricting member applied to the pressure sensor according to the second embodiment.

The restricting member 340 according to the third variation example is formed as a molded rubber having a long columnar shape in the axis S direction by a mold or the like using the same rubber material as described above.

The restricting member 340 has the same length dimension L4 as described above, and includes an outer peripheral fitting surface 340a and a fitting hole 341.

The outer peripheral fitting surface 340a is formed to have an outer diameter dimension that allows the outer peripheral fitting surface 340a to be closely fitted, here, press-fitted to the inner wall surface of the through hole 13.

The fitting hole 341 is arranged coaxially with the axis S and extends to penetrate in the axis S direction so as to allow the lead wire 290 to be closely fitted and inserted therethrough.

According to the restricting member 340 of the third variation example, the lead wire 290 can be fixed and held more firmly.

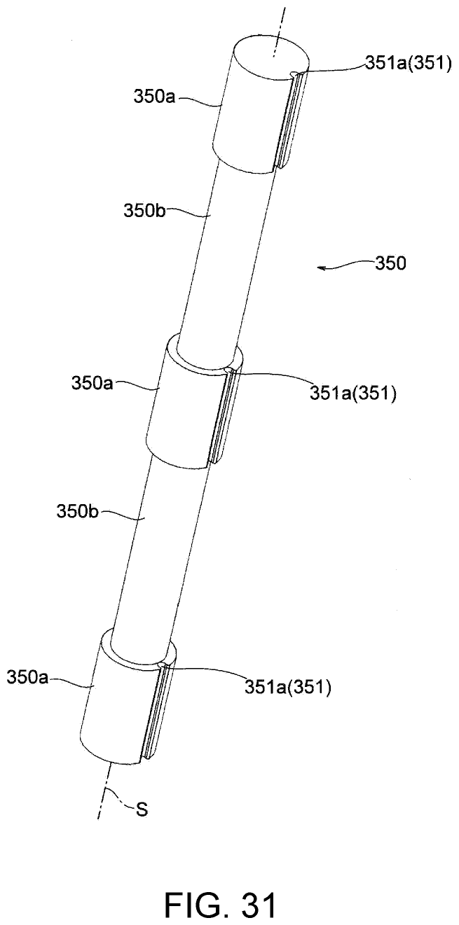

FIG. 31 shows a fourth variation example of the restricting member applied to the pressure sensor according to the second embodiment.

The restricting member 350 according to the fourth variation example is formed as a molded rubber having a long multi-stage columnar shape in the axis S direction by a mold or the like using the same rubber material as described above.

The restricting member 350 has the same length dimension L4 as described above, and includes three outer peripheral fitting surfaces 350a, two hollowed portions 350b, and a fitting groove 351.

The three outer peripheral fitting surfaces 350a are spaced apart from each other at equal intervals in the axis S direction, and are formed to have an outer diameter dimension that allows the outer peripheral fitting surfaces 350a to be closely fitted, here, press-fitted to the inner wall surface of the through hole 13 of the outer housing 210.

The two hollowed portions 350b are separated in the axis S direction and are arranged among the three outer peripheral fitting surfaces 350a. The two hollowed portions 350b are formed by removing the material so as to form a columnar shape having an outer diameter smaller than that of the outer peripheral fitting surface 350a.

The two hollowed portions 350b are regions that are not in contact with the inner wall surface of the through hole 13 when the restricting member 350 is fitted into the through hole 13 of the outer housing 210.

That is, the restricting member 350 is formed so as to be partially in contact with the inner wall surface of the housing.

The fitting groove 351 is defined by three fitting grooves 351a arranged apart from each other in the axis S direction, and extends in the axis S direction so as to allow the lead wire 290 to be closely fitted and inserted therethrough.

Similar to the case shown in FIG. 15, in the region of the outer peripheral fitting surface 350a, the fitting groove 351a is formed in a substantially semicircular cross-sectional shape on the plane perpendicular to the axis S.

According to the restricting member 350 of the fourth variation example, the same operational effects as those of the restricting members 300, 320 and 330 can be obtained.

In addition, because the fitting groove 351 has a substantially semicircular cross section and the lead wire 290 is held and fixed between the fitting groove 351 and the inner wall surface of the through hole 13, the fitting operation of the restricting member 350 can be performed more smoothly.

In the first and second embodiments, the length dimensions L2 and L4 of the restricting members 100, 120, 130, 140, 150, 160, 300, 320, 330, 340 and 350 are shown slightly shorter than the length dimensions L1 and L3 of the through hole 13. However, the length dimensions L2 and L4 are not limited thereto, and a restricting member having a shorter dimension may be adopted as long as the relative movement between the first conductor (the first lead wire 91, the outer housing 210) and the second conductor (the second lead wire 92, the lead wire 290) can be restricted.

In the first and second embodiments, the diaphragm 30 integrally provided with the flexible plate-shaped portion 31 and the protrusion 32 is shown as the diaphragm. However, the diaphragm is not limited thereto, and a configuration may be adopted in which the flexible plate-shaped portion 31 and the protrusion 32 are separately formed, the flexible plate-shaped portion 31 functions as the diaphragm, and the protrusion 32 functions as a force transmission member.

In the first and second embodiments, the housing includes the outer housings 10, 210 and the sub-housing 20. However, the housing is not limited thereto, and one housing may be adopted.

In the first and second embodiments, the pressure sensor provided with the heat insulating members 60 and 260 is shown. However, the pressure sensor is not limited thereto, and the heat insulating members 60 and 260 may be abolished.

In the first embodiment, the first lead wire 91 is shown as the first conductor and the second lead wire 92 is shown as the second conductor. In the second embodiment, the lead wire 290 is shown as the second conductor. However, the conductor is not limited thereto, and a pin-shaped conductor or a conductor having other forms may be adopted as long as the conductor has a long size in the axis S direction.

In the first and second embodiments, the molded rubber being an elastic material is used as the restricting member. However, the restricting member is not limited thereto, and a fluid filler may be filled and cured so as not to flow into the region of the preload applying members 80 and 280.

In the first embodiment, the restricting members 100, 120, 130, 140, 150 and 160 are closely fitted to the through holes 13 of the outer housing 10. However, the restricting members need not to be arranged in such a manner, and a restricting member arranged in the outer housing 10 without contacting the inner wall surface of the through hole 13 may be adopted as long as the relative movement between the first lead wire 91 and the second lead wire 92 can be restricted.

As described above, the pressure sensor of the present invention can suppress or prevent variations in parasitic capacitance so as to suppress or prevent occurrence of noise, and thus can be used not only as a pressure sensor for detecting pressure, particularly, the pressure of combustion gas in a combustion chamber of an engine accompanied by vibration, but also as a pressure sensor for detecting pressure of a pressure medium of a device arranged in a vibration environment other than the engine.

### REFERENCE SIGNS LIST

S axis
10 outer housing (housing)
20 sub-housing (housing)
30 diaphragm
70 pressure measuring member
71 first electrode
72 piezoelectric element
73 second electrode
80 preload applying member
91 first lead wire (first conductor)
92 second lead wire (second conductor)
100, 120, 130, 140, 150, 160 restricting member
101 first fitting hole
102 second fitting hole
121, 131, 141, 151, 161 first fitting groove
122, 132, 142, 152, 162 second fitting groove
110 connector
112 first terminal
113 second terminal
210 outer housing (housing, first conductor)
270 pressure measuring member
273 second electrode
280 preload applying member
290 lead wire (second conductor)
310 connector
312 terminal
300, 320, 330, 340, 350 restricting member
301, 321, 331, 341 fitting hole
351 fitting groove

1. A pressure sensor comprising:
a housing in a cylindrical shape;
a diaphragm, fixed to a front end of the housing and exposed to a pressure medium;
a pressure measuring member comprising a first electrode, a piezoelectric element and a second electrode laminated in sequence inside the housing;
a first conductor in a long shape, electrically connected to the first electrode;
a second conductor in a long shape, electrically connected to the second electrode; and
a restricting member having insulation, arranged in the housing and configured to restrict a relative movement between the first conductor and the second conductor.

2. The pressure sensor according to claim 1, wherein
the restricting member is formed of an elastic material.

3. The pressure sensor according to claim 2, further comprising:
a preload applying member, arranged inside the housing and configured to press the pressure measuring member toward the diaphragm to apply a preload,
wherein the restricting member is arranged in a region deviating from the preload applying member.

4. The pressure sensor according to claim 3, wherein the housing comprises:
an outer housing; and
a sub-housing, being fitted and fixed inside the outer housing,
wherein the diaphragm, the pressure measuring member, and the preload applying member are arranged in the sub-housing, and
the restricting member is arranged in the outer housing.

5. The pressure sensor according to claim 3, wherein
the first conductor is a first lead wire arranged inside the housing,
the second conductor is a second lead wire arranged inside the housing, and
the first lead wire and the second lead wire are fitted and fixed to the restricting member.

6. The pressure sensor according to claim 5, wherein
the restricting member is fitted and fixed to the housing.

7. The pressure sensor according to claim 5, further comprising:
a connector, fixed to a rear end of the housing,
wherein the first lead wire is electrically connected to a first terminal of the connector,
the second lead wire is electrically connected to a second terminal of the connector, and
the restricting member is arranged between the preload applying member, and the first terminal and the second terminal.

8. The pressure sensor according to claim 5, wherein
the restricting member is formed as a molded rubber having a long columnar shape in an axial direction of the housing, and
wherein the molded rubber comprises:
a first fitting hole that extends to penetrate in the axial direction so as to allow the first lead wire to be fitted and inserted therethrough; and
a second fitting hole that extends to penetrate in the axial direction so as to allow the second lead wire to be fitted and inserted therethrough.

9. The pressure sensor according to claim 5, wherein
the restricting member is formed as a molded rubber having a long columnar shape in an axial direction of the housing, and
wherein the molded rubber comprises:
a first fitting groove that extends in the axial direction so as to allow the first lead wire to be fitted and inserted therethrough; and
a second fitting groove that extends in the axial direction so as to allow the second lead wire to be fitted and inserted therethrough.

10. The pressure sensor according to claim 8, wherein
the restricting member is formed so as to be partially in contact with an inner wall surface of the housing.

11. The pressure sensor according to claim 3, wherein
the housing is formed so as to also serve as the first conductor,
the second conductor is a lead wire arranged inside the housing,
the lead wire is fitted and fixed to the restricting member, and
the restricting member is fitted and fixed to the housing.

12. The pressure sensor according to claim 11, further comprising:
a connector, fixed to a rear end of the housing,
the lead wire is electrically connected to a terminal of the connector, and
the restricting member is arranged between the terminal and the preload applying member.

13. The pressure sensor according to claim 11, wherein
the restricting member is formed as a molded rubber having a long columnar shape in an axial direction of the housing, and
wherein the molded rubber comprises a fitting hole that extends to penetrate in the axial direction so as to allow the lead wire to be fitted and inserted therethrough.

14. The pressure sensor according to claim 11, wherein
the restricting member is formed as a molded rubber having a long columnar shape in the axial direction of the housing, and
wherein the molded rubber comprises a fitting groove that extends in the axial direction so as to allow the lead wire to be fitted and inserted therethrough.

15. The pressure sensor according to claim 13, wherein
the restricting member is formed so as to be partially in contact with an inner wall surface of the housing.
